(19) United States
(12) Patent Application Publication
(10) Pub. No.: US 2025/0159697 A1
(43) Pub. Date: May 15, 2025

(54) METHODS AND APPARATUSES OF RESOURCE ALLOCATION FOR SIDELINK COMMUNICATION

(71) Applicant: LENOVO (BEIJING) LIMITED, BEIJING (CN)

(72) Inventors: XIN GUO, BEIJING (CN); HAIPENG LEI, BEIJING (CN); ZHENNIAN SUN, BEIJING (CN); XIAODONG YU, BEIJING (CN)

(21) Appl. No.: 18/726,109

(22) PCT Filed: Dec. 31, 2021
(86) PCT No.: PCT/CN2021/144070

§ 371 Date: Jul. 1, 2024

(51) Int. Cl. H04W 72/25; H04L 5/00

(52) U.S. Cl. CPC H04W 72/25; H04L 5/0094

(57) ABSTRACT

The present disclosure relates to methods and apparatuses of resource allocation for sidelink (SL) communication. A user equipment (UE) includes a processor configured to: obtain sidelink indicator (SL-I) configuration information associated with a resource pool (RP) based on configuration or pre-configuration. The SL-I configuration information indicates at least one of: a structure of resource(s) available for SL-I transmission; an association between resource(s) available for SL-I transmission and resource(s) for corresponding SL transmission(s); or a priority threshold. The processor performs a sensing-based resource selection or sensing-based resource reselection in the RP and performs an operation associated with SL-I according to the SL-I configuration information. Performing the operation comprises: transmitting (or checking) an SL-I indicating at least one of reserved resource(s) for an intended SL transmission of the UE (or another UE), or a priority of the intended SL transmission of the UE (or of the other UE).

### TECHNICAL FIELD

Embodiments of the present application are related to wireless communication technology, and more particularly, to methods and apparatuses of resource allocation for sidelink (SL) communication.

### BACKGROUND

A sidelink is a long-term evolution (LTE) feature introduced in 3rd generation partnership project (3GPP) Release 12, that enables a direct communication between proximal user equipments (UEs), in which data does not need to go through a base station (BS) or a core network. A sidelink communication system has been introduced into 3GPP 5G wireless communication technology, in which a direct link between two UEs is called a sidelink.

3GPP 5G networks are expected to increase network throughput, coverage and reliability, and to reduce latency and power consumption. With the development of 3GPP 5G networks, various aspects need to be studied and developed to perfect the 5G technology. Currently, details regarding resource allocation for sidelink communication need to be further discussed in 3GPP 5G technology.

### SUMMARY OF THE APPLICATION

Embodiments of the present application at least provide a technical solution of resource allocation for sidelink communication.

According to some embodiments of the present application, a method performed by a UE may include: obtaining sidelink (SL) indicator (SL-I) configuration information associated with a resource pool (RP) based on configuration or pre-configuration, wherein the SL-I configuration information indicates at least one of: a structure of resource(s) available for SL-I transmission; an association between the resource(s) available for SL-I transmission and resource(s) for corresponding SL transmission(s); or a priority threshold. The method may also include: performing a sensing-based resource selection or sensing-based resource reselection in the RP; and performing an operation associated with SL-I according to the SL-I configuration information, where performing the operation includes: transmitting an SL-I indicating at least one of reserved resource(s) for an intended SL transmission of the UE or a priority of the intended SL transmission of the UE; or checking an SL-I indicating at least one of reserved resource(s) for an intended SL transmission of another UE or a priority of the intended SL transmission of the other UE.

In some embodiments of the present application, the SL-I configuration information is configured per resource pool or per zone.

In some embodiments of the present application, the method may further include: obtaining configuration information associated with the RP, where the configuration information indicates at least one of: only slot level SL transmission is enabled in the RP; only sub-slot level SL transmission is enabled in the RP; or both slot level SL transmission and sub-slot level SL transmission are enabled in the RP.

In some embodiments of the present application, the SL-I configuration information includes at least one of the following information to indicate the structure of the resource(s) available for SL-I transmission: a sub-slot pattern or a slot pattern for SL-I transmission; or half-symbol(s) or symbol(s) for SL-I transmission.

In some embodiments of the present application, the symbol(s) for SL-I transmission are included in a physical sidelink feedback channel (PSFCH).

In some embodiments of the present application, the SL-I configuration information includes at least one of the following information to indicate the structure of the resource(s) available for SL-I transmission: sub-channel(s) in each half-symbol of the half-symbol(s) or each symbol of the symbol(s) for SL-I transmission; a number of physical resource blocks (PRBs) in each sub-channel in each half-symbol of the half-symbol(s) or each symbol of the symbol(s) for SL-I transmission; a number of PRB sets in each sub-channel in each half-symbol of the half-symbol(s) or each symbol of the symbol(s) for SL-I transmission; at least one sequence type used for SL-I transmission; or at least one code used for SL-I transmission

In some embodiments of the present application, the SL-I configuration information includes the following information to indicate the association between the resource(s) available for SL-I transmission and the resource(s) for the corresponding SL transmission(s): an association between a first group of indexes associated with the resource(s) available for SL-I transmission and a second group of indexes associated with the resource(s) for the corresponding SL transmission(s), where the first group of indexes includes at least one of: SL slot index(es) associated with the resource(s) available for SL-I transmission, sub-slot index(es) associated with the resource(s) available for SL-I transmission, sub-chancel index(es) associated with the resource(s) available for SL-I transmission, PRB set index(es) associated with the resource(s) available for SL-I transmission, PRB index(es) associated with the resource(s) available for SL-I transmission, code index(es) associated with the resource(s) available for SL-I transmission, or available resource index(es) associated with the resource(s) available for SL-I transmission; and wherein the second group of indexes includes at least one of: SL slot index(es) associated with the resource(s) for the corresponding SL transmission(s); sub-slot index(es) associated with the resource(s) for the corresponding SL transmission(s); or sub-chancel index(es) associated with the resource(s) for the corresponding SL transmission(s).

In some embodiments of the present application, the priority of the intended SL transmission of the UE or the priority of the intended SL transmission of the other UE is indicated by at least one of: a sequence type associated with the SL-I; a PRB index associated with the SL-I; a code index associated with the SL-I; or an available resource index associated with the SL-I.

In some embodiments of the present application, the method may further include: in the case that the priority threshold is not indicated by the SL-I configuration information, checking the SL-I once a resource selection or a resource reselection is triggered; or in the case that the priority threshold is indicated by the SL-I configuration information, checking the SL-I once a resource selection or a resource reselection is triggered in response to a priority of an intended slot level or sub-slot level SL transmission of the UE being lower than the priority threshold.

In some embodiments of the present application, the method may further include: freeing resources(s) originally reserved for the intended slot level or sub-slot level SL transmission of the UE and re-select resource(s) for the intended slot level or sub-slot level SL transmission of the UE once at least one of the following conditions is satisfied: the resources(s) originally reserved for the intended slot level or sub-slot level SL transmission of the UE at least partially overlap the reserved resource(s) for the intended SL transmission of the another UE indicated by a detected SL-I; or the priority of the intended SL transmission of the other UE indicated by a detected SL-I is higher than the priority of the intended slot level or sub-slot level SL transmission of the UE.

In some embodiments of the present application, the method may further include: in the case that the priority threshold is indicated by the SL-I configuration information, transmitting the SL-I in response to a priority of the intended SL transmission of the UE being higher than the priority threshold; or in the case that the priority threshold is not indicated by the SL-I configuration information: transmitting the SL-I after a resource selection or a resource reselection is triggered; or transmitting the SL-I in the case that the priority of the intended SL transmission of the UE is higher than an estimated priority of an SL transmission from another UE on resource(s) which at least partially overlap the reserved resource(s) for the intended SL transmission of the UE.

According to some other embodiments of the present application, a method performed by a BS may include transmitting at least one of the following information: SL-I configuration information associated with a RP, where the SL-I configuration information indicates at least one of: a structure of resource(s) available for SL-I transmission; an association between the resource(s) available for SL-I transmission and resource(s) for corresponding SL transmission(s); or a priority threshold; or configuration information associated with the RP, where the configuration information indicates at least one of: only slot level SL transmission is enabled in the RP; only sub-slot level SL transmission is enabled in the RP; or both slot level SL transmission and sub-slot level SL transmission are enabled in the RP.

Some embodiments of the present application also provide a UE including: a processor configured to cause the UE to: obtain SL-I configuration information associated with a RP based on configuration or pre-configuration, where the SL-I configuration information indicates at least one of: a structure of resource(s) available for SL-I transmission; an association between the resource(s) available for SL-I transmission and resource(s) for corresponding SL transmission(s); or a priority threshold. The processor is further configured to cause the UE to: perform a sensing-based resource selection or sensing-based resource reselection in the RP; and perform an operation associated with SL-I according to the SL-I configuration information, where performing the operation comprises: transmitting an SL-I indicating at least one of reserved resource(s) for an intended SL transmission of the UE or a priority of the intended SL transmission of the UE; or checking an SL-I indicating at least one of reserved resource(s) for an intended SL transmission of another UE or a priority of the intended SL transmission of the another UE. The UE includes a transmitter coupled to the processor and a receiver coupled to the processor.

Some other embodiments of the present application also provide a BS including: a processor configured to cause the BS to transmit at least one of the following information: SL-I configuration information associated with a RP, where the SL-I configuration information indicates at least one of: a structure of resource(s) available for SL-I transmission; an association between the resource(s) available for SL-I transmission and resource(s) for corresponding SL transmission(s); or a priority threshold; or configuration information associated with the RP. The configuration information indicates at least one of: only slot level SL transmission is enabled in the RP; only sub-slot level SL transmission is enabled in the RP; or both slot level SL transmission and sub-slot level SL transmission are enabled in the RP. The BS includes a transmitter coupled to the processor and a receiver coupled to the processor.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of the scope of the application.

FIG. 1 is a schematic diagram illustrating an exemplary wireless communication system according to some embodiments of the present application;

FIG. 2 illustrates two exemplary sidelink slot patterns according to some embodiments of the present application;

FIG. 3 illustrates an exemplary sidelink sub-slot pattern according to some embodiments of the present application;

FIG. 4 illustrates another exemplary sidelink sub-slot pattern according to some other embodiments of the present application;

FIG. 5 illustrates exemplary sensing-based resource (re-)selection procedures according to some embodiments of the present application;

FIG. 6 illustrates an exemplary resource allocation according to some embodiments of the present application;

FIG. 7 illustrates an exemplary flowchart of a method for resource allocation according to some embodiments of the present application;

FIG. 8 illustrates exemplary resources for SL-I transmission and corresponding SL transmission according to some embodiments of the present application;

FIG. 9 illustrates exemplary resources for SL-I transmission and corresponding SL transmission according to some other embodiments of the present application;

FIG. 10 illustrates exemplary resources for SL-I transmission and corresponding SL transmission according to some other embodiments of the present application;

FIG. 11 illustrates exemplary resources for SL-I transmission and corresponding SL transmission according to some other embodiments of the present application;

FIG. 12 illustrates exemplary resources for SL-I transmission and corresponding SL transmission according to some other embodiments of the present application;

FIG. 13 illustrates exemplary resources for SL-I transmission and corresponding SL transmission according to some other embodiments of the present application;

FIG. 14 illustrates exemplary resources for SL-I transmission and corresponding SL transmission according to some other embodiments of the present application; and

FIG. 15 illustrates a simplified block diagram of an exemplary apparatus for resource allocation according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G new radio (NR), 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

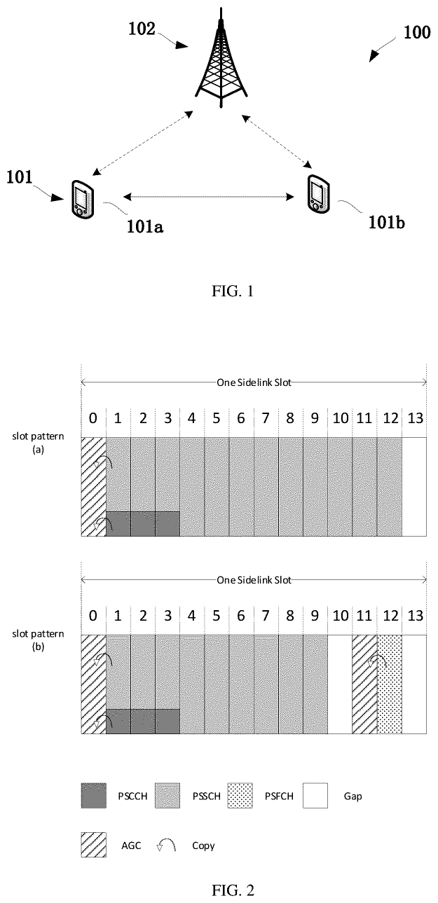

FIG. 1 illustrates an exemplary wireless communication system 100 in accordance with some embodiments of the present application.

As shown in FIG. 1, a wireless communication system 100 includes at least one user equipment (UE) 101 and at least one base station (BS) 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present application, UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

In some embodiments of the present application, a UE is a pedestrian UE (P-UE or PUE) or a cyclist UE. In some embodiments of the present application, UE(s) 101 includes wearable devices, such as smart watches, fitness bands, optical head-mounted displays, or the like. Moreover, UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) 101 may communicate directly with BSs 102 via LTE or NR Uu interface. Moreover, UE(s) 101 may work in a wider Internet-of-Thing (IoT) or Industrial IoT (IIOT) scenario with increased demand(s) of low air-interface latency and/or high reliability to be addressed, such as factory automation, electrical power distribution, and/or transport industry.

In some embodiments of the present application, each of UE(s) 101 may be deployed an IoT application, an enhanced mobile broadband (eMBB) application and/or an ultra-reliable and low latency communications (URLLC) application. For instance, UE 101a may implement an IoT application and may be named as an IoT UE, while UE 101b may implement an eMBB application and/or a URLLC application and may be named as an eMBB UE, a URLLC UE, or an eMBB/URLLC UE. It is contemplated that the specific type of application(s) deployed in UE(s) 101 may be varied and not limited.

In a sidelink communication system, a transmission UE may also be named as a transmitting UE, a Tx UE, a sidelink Tx UE, a sidelink transmission UE, or the like. A reception UE may also be named as a receiving UE, an Rx UE, a sidelink Rx UE, a sidelink reception UE, or the like.

According to some embodiments of FIG. 1, UE 101a functions as a Tx UE, and UE 101b functions as an Rx UE. UE 101a may exchange sidelink messages with UE 101b through a sidelink, for example, via PC5 interface as defined in 3GPP TS 23.303. UE 101a may transmit information or data to other UE(s) within the sidelink communication system, through sidelink unicast, sidelink groupcast, or sidelink broadcast. For instance, UE 101a may transmit data to UE 101b in a sidelink unicast session. UE 101a may transmit data to UE 101b and other UE(s) in a groupcast group (not shown in FIG. 1) by a sidelink groupcast transmission session. Also, UE 101a may transmit data to UE 101b and other UE(s) (not shown in FIG. 1) by a sidelink broadcast transmission session.

Alternatively, according to some other embodiments of FIG. 1, UE 101b functions as a Tx UE and transmits sidelink messages, and UE 101a functions as an Rx UE and receives the sidelink messages from UE 101b.

Both UE 101a and UE 101b in the embodiments of FIG. 1 may transmit information to BS(s) 102 and receive control information from BS(s) 102, for example, via LTE or NR Uu interface. BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high e platform network, and/or other communications networks.

In some embodiments of the present application, the wireless communication system 100 is compatible with the 5G NR of the 3GPP protocol, wherein BS(s) 102 transmit data using an orthogonal frequency division multiplexing (OFDM) modulation scheme on the downlink (DL) and UE(s) 101 transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of the present application, BS(s) 102 may communicate with UE(s) 101 using the 3GPP 5G protocols.

In general, support for an NR SL is firstly introduced in 3GPP Rel-16. Although the resource pool configuration has a slot-based granularity in the time domain, this does not preclude the case in which only a limited set of consecutive symbols within a sidelink slot is actually available for sidelink communication. The limited set of consecutive symbols can be configured by the first symbol of the set of consecutive symbols available for sidelink communication and the number of consecutive symbols available for sidelink communication. Without loss of generality, this application only illustrates examples where all 14 OFDM symbols within a sidelink slot are available for sidelink communication. As per NR sidelink slot specified in 3GPP Rel-16: the first of the available OFDM symbols for sidelink communication of a sidelink slot is a copy of the second of the available OFDM symbols for sidelink communication of the sidelink slot; and the first of the available OFDM symbols for sidelink communication is used for an automatic gain control (AGC) purpose. The operation of AGC is performed by a UE when receiving a signal to determine the amplification degree, and thus, the UE can adjust the gain of the receiver amplifier to fit the power of the received signal. The specific examples are shown in FIG. 2, which are described as below.

FIG. 2 illustrates two exemplary sidelink slot patterns (or formats) according to some embodiments of the present application. As shown in FIG. 2, the two exemplary sidelink slot patterns may be referred to as slot pattern (a) and slot pattern (b). In the slot pattern (a) and slot pattern (b), one sidelink slot includes 14 OFDM symbols in total, i.e., OFDM symbol #0 to OFDM symbol #13. OFDM symbol #0 is used for AGC by repeating the first OFDM symbol (i.e., OFDM symbol #1) carrying physical sidelink shared channel (PSSCH) and/or physical sidelink control channel (PSCCH) transmissions. The last available OFDM symbol, i.e., OFDM symbol #13, is always used as a guard symbol (i.e., a gap). In addition, OFDM symbol #1, OFDM symbol #2, and OFDM symbol #3 are used to carry PSSCH and PSCCH transmissions. OFDM Symbol #4 to OFDM symbol #9 are used to carry PSSCH transmissions. An OFDM symbol carrying PSSCH and/or PSCCH transmissions may be named as “a PSSCH and/or PSCCH OFDM symbol”, “a PSSCH and/or PSCCH symbol”, or the like.

In the embodiments of FIG. 2, the difference between slot pattern (a) and slot pattern (b) is OFDM Symbol #10 to OFDM symbol #12. Specifically, in slot pattern (a), OFDM Symbol #10 to OFDM symbol #12 are used to carry PSSCH transmissions. However, in slot pattern (b), the hybrid automatic repeat request (HARQ) feedback is enabled for the sidelink slot, and then a PSFCH transmission is transmitted in the second to last available OFDM symbol (i.e., OFDM symbol #12 as shown in slot pattern (b) in FIG. 2) of the sidelink slot. An OFDM symbol carrying a PSFCH transmission may be named as “a PSFCH OFDM symbol”, “a PSFCH symbol”, or the like. One OFDM symbol right prior to the PSFCH symbol may be used for AGC and may comprise a copy of the PSFCH symbol. For example, OFDM symbol #11 as shown in slot pattern (b) in FIG. 2 is used for AGC by repeating the PSFCH symbol #12 as shown in slot pattern (b) in FIG. 2.

In some embodiments, a guard symbol between the PSSCH and/or PSCCH symbol and the PSFCH symbol is needed to provide switching time between “a PSSCH and/or PSCCH reception” and “a PSFCH transmission” (i.e., OFDM symbol #10 as shown in slot pattern (b) in FIG. 2). This implies that, if PSFCH resources are configured for a sidelink slot, this will use a total of three OFDM symbols, including the AGC symbol and the extra guard symbol.

Considering that the AGC setting time occupies only 15 microseconds (i.e., μsec or μs), and the assumption for the necessary transmission/reception (Tx/Rx) switching gap is 13 μsec while the symbol duration for 15 kHz subcarrier spacing (SCS) is equal to 66.67 μsec and the symbol duration for 30 kHz SCS is equal to 33.33 μsec, it is inefficient to use a whole symbol working as AGC for some SCS, such as, 15 kHz or 30 kHz.

Currently, in emerging latency critical applications (e.g., a factory automation scenario), lower latency requirements are needed and thus cannot be satisfied by a slot-based sidelink transmission. For example, if SCSs are configured per resource pool and if a desired resource pool is configured with a shorter SCS (such as, 15 kHz or 30 kHz), it is required to reduce the transmission latency for the configured SCS. This implies that the latency on the resource pool cannot be reduced by applying a longer SCS. Therefore, sub-slot based sidelink slot pattern (or format) is introduced in supporting low latency and high spectrum efficiency sidelink transmission, which includes the following components such as full-symbol (FS), half-symbol (HS), and combined-symbol (CS).

For instance, the following three types of FS are defined.
(1) FS₁ is defined as an FS which is for carrying PSSCH and/or PSCCH transmissions.
(2) FS₂ is defined as an FS which is for carrying a PSSCH transmission.
(3) FS₃ is defined as an FS which is for carrying a PSFCH transmission.

For instance, the following four types of HS are defined.
(1) HS₁ is defined as an HS which is “a copy of the first half of the nearest PSSCH and/or PSCCH symbol after the HS” or “a copy of the first half of the nearest PSFCH symbol after the HS”. For example, HS₁ can be used for AGC.
(2) HS₂ is defined as an HS which works as a gap for Tx/Rx switching.
(3) HS₃ is defined as an HS which is “a copy of the second half of the nearest PSSCH and/or PSCCH symbol before the HS” or “a copy of the second half of the nearest PSFCH symbol before the HS”. For example, HS₃ can be used for reliability improvement.
(4) HS₄ is defined as an HS carrying extra information by transmitting a preamble sequence. The information carried in HS₄ can be used for supporting a sub-slot based transmission. For example, HS₄ can be used for increasing spectrum efficiency. Or, HS₄ can be used for padding a symbol.

For instance, the following four types of CS are defined.
(1) CS₁ is defined as including two half-symbols, in which the first half of the combined-symbol is HS₁, and the second half of the combined-symbol is HS₄.
(2) CS₂ is defined as including two half-symbols, in which the first half of the combined-symbol is HS₃, and the second half of the combined-symbol is HS₂.
(3) CS₃ is defined as including two half-symbols, in which the first half of the combined-symbol is HS₂, and the second half of the combined-symbol is HS₁.
(4) CS₄ is defined as including two half-symbols, in which the first half of the combined-symbol is HS₄, and the second half of the combined-symbol is HS₂.

Currently, for instance, the following two types of sidelink sub-slots are defined.
(1) Sub-slot type SS_{A} does not include symbol(s) of a PSFCH transmission. That is, SS_{A} includes only “PSSCH and/or PSCCH transmissions” or only “a PSSCH transmission”. Sub-slot type SS_{A} can be further classified as follows:
   a) Sub-slot type SS_{A1} includes one CS₁, at least one FS₁, and one CS₂.
   b) Sub-slot type SS_{A2} includes one CS₁, at least one FS₁, and one HS₂.
   c) Sub-slot type SS_{A3} includes one HS₁, at least one FS₁, and one CS₂.
   d) Sub-slot type SS_{A4} includes one HS₁, at least one FS₁, and one HS₂.
(2) Sub-slot type SS_{B} does not include symbol(s) of PSSCH and/or PSCCH transmissions. That is, SS_{B} includes only a PSFCH transmission. Sub-slot type SS_{B} can be further classified as follows:
   a) Sub-slot type SS_{B1} includes one HS₁, at least one FS₃, and one CS₂.
   b) Sub-slot type SS_{B2} includes one HS₁, at least one FS₃, and one CS₄.
   c) Sub-slot type SS_{B3} includes one HS₁, at least one FS₃, and one HS₂.

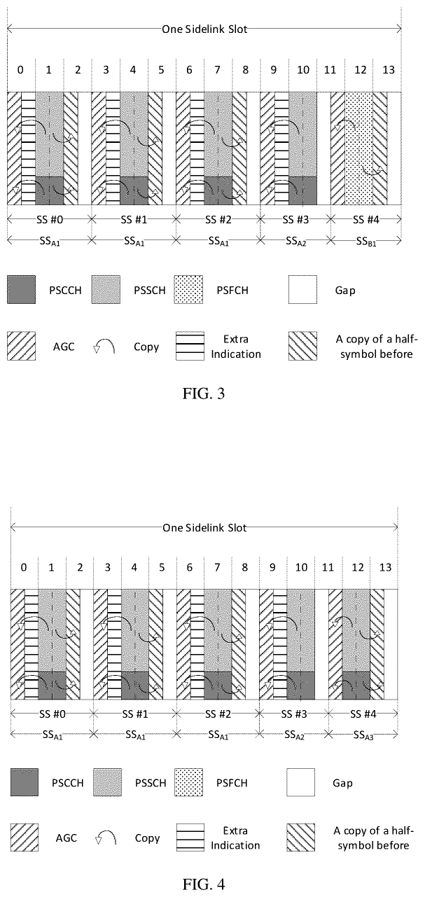

FIG. 3 illustrates an exemplary sidelink sub-slot pattern according to some embodiments of the present application. In the embodiments of FIG. 3, one sidelink slot includes 14 OFDM symbols in total, i.e., OFDM symbol #0 to OFDM symbol #13.

According to the embodiments of FIG. 3, the sidelink slot as illustrated by FIG. 3 includes five sidelink sub-slots in total, i.e., SS #0, SS #1, SS #2, SS #3, and SS #4. All of SS #0, SS #1, and SS #2 belong to sub-slot type SS_{A1}, which includes one CS₁, one FS₁ and one CS₂. SS #3 belongs to sub-slot type SS_{A2}, which includes one CS₁, one FS₁ and one HS₂. SS #4 belongs to sub-slot type SS_{B1}, which includes one HS₁, one FS₃ and one CS₂.

FIG. 4 illustrates another exemplary sidelink sub-slot pattern according to some other embodiments of the present application. In the embodiments of FIG. 4, one sidelink slot includes 14 OFDM symbols in total, i.e., OFDM symbol #0 to OFDM symbol #13.

According to the embodiments of FIG. 4, the sidelink slot as illustrated by FIG. 4 includes five sidelink sub-slots in total, i.e., SS #0, SS #1, SS #2, SS #3, and SS #4. All of SS #0, SS #1, and SS #2, and SS #3 are the same as SS #0, SS #1, SS #2, and SS #3 in FIG. 3, respectively. The difference is that in the embodiments of FIG. 4, SS #4 belongs to sub-slot type SS_{A3}, which includes one HS₁, one FS₁, and one CS₂.

The sidelink sub-slot patterns (also referred to as sub-slot patterns) in FIGS. 3 and 4 are only for illustrative purpose. It is contemplated that the sub-slot patterns may be other patterns according to some other embodiments of the present application, and that one slot may include more than two sub-slots.

For sidelink transmission, resource allocation may be implemented by two modes, i.e., resource allocation mode 1 and resource allocation mode 2.

In the case of resource allocation mode 1, a sidelink transmission (e.g., a PSSCH transmission and/or a PSCCH transmission) can only be carried out by a UE if the UE has been provided with a valid scheduling grant that indicates the exact set of resources used for the sidelink transmission. Assuming that both slot-level resource allocation and sub-slot level resource allocation are configured in one RP, dynamic grant implies that the scheduling grant can be made in different time intervals, i.e., either slot or sub-slot.

In the case of resource allocation mode 2, a decision on sidelink transmission, including decision on the exact set of resources to be used for the sidelink transmission, is made by the transmitting UE (also referred to as Tx UE) based on a sensing-based resource (re-)selection procedure. Resource allocation mode 2 is applicable to both in-coverage and out-of-coverage deployment scenarios.

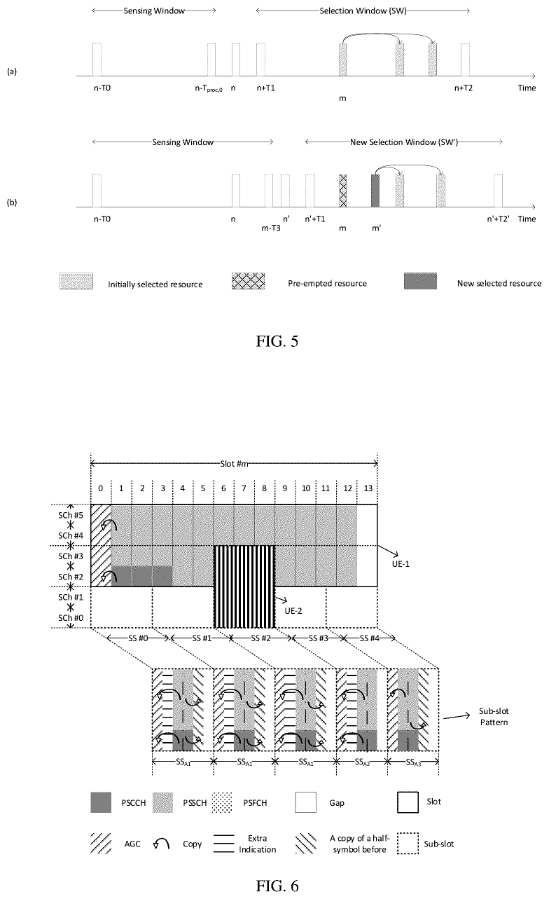

FIG. 5 illustrates exemplary sensing-based resource (re-)selection procedures according to some embodiments of the present application, which include sensing-based resource (re-)selection procedure (a) (hereinafter referred to as procedure (a)) and sensing-based resource (re-)selection procedure (b) (hereinafter referred to as procedure (b)).

Referring to procedure (a), the resource (re-)selection is triggered at slot n by a UE. The UE defines a selection window (SW) that starts at slot n+T1 and ends at slot n+T2. The UE may select resources in the SW based on sensing results from the sensing window that starts at slot n−T0 and ends at slot n−T_{proc,0}. In the SW, the UE can select and reserve up to three resources for transmission and retransmission of one transport block (TB), where the first reserved resource is assumed at slot m. During the initial transmission of the TB at slot m, the remaining two reserved resources are indicated by 1^{st}-stage sidelink control information (SCI) in the initial transmission.

Procedure (a) shows a sensing-based resource (re-)selection procedure without pre-emption. However, in some cases, the sensing-based resource (re-)selection procedure may use a pre-emption mechanism. In the pre-emption mechanism, a UE having a traffic with a lower priority must free its reserved resource if it estimates that another UE having a traffic with a higher priority will use the reserved resource. In some cases, when a priority threshold is (pre-) configured in the resource pool, the UE only frees its reserved resource in the case that the priority of the traffic of another UE is higher than the priority threshold. Pre-emption mechanism may apply to both the dynamic scheduling scheme and the semi-persistent scheduling scheme.

Referring to procedure (b), it shows a sensing-based resource (re-)selection procedure with pre-emption. Similar to procedure (a), in procedure (b), the resource (re-)selection is triggered at slot n by UE-1 and three resources are firstly selected by the UE-1, where the first reserved resource is at slot m. The difference between procedure (b) and procedure (a) is that in procedure (b), the UE-1 keeps sensing after slot n for a certain time duration (e.g., defined as [n, m−T3]). Assuming that the UE-1 initiates an exclusion of candidate resources at slot n′, then a new selection window (SW′) may be defined as [n′+T1, n′+T2′]. According to further sensing results, the first reserved resource at slot m is occupied by another UE (e.g., UE-2) having a traffic with a higher priority. Thus, the UE-1 has to free its reserved resource at slot m and reselect new resources in SW′, e.g., the first reserved resource of the newly selected resources is at slot m′.

The pre-emption mechanism in procedure (b) may be applied to a slot level SL transmission. However, how to indicate the pre-emption of resources for a sub-slot level SL transmission has not been discussed yet.

FIG. 6 illustrates an exemplary resource allocation according to some embodiments of the present application. In the embodiments of FIG. 6, both UE-1 and UE-2 may select resources for SL transmission under resource allocation mode 2.

Referring to FIG. 6, UE-1 may select a set of resources for SL transmission (e.g., based on a sensing-based resource selection procedure as shown in FIG. 5). The set of resources may include one slot (e.g., slot #m) in the time domain and four consecutive sub-channels from SCh #2 to SCh #5 in the frequency domain. In the embodiments of FIG. 6, one slot may include 14 OFDM symbols in total, i.e., OFDM symbol #0 to OFDM symbol #13. Although a specific number of OFDM symbols in one sidelink slot are depicted in FIG. 6, it is contemplated that any number of OFDM symbols as specified in 3GPP standards may be included in one sidelink slot.

For a latency-critical traffic transmission of UE-2, the UE-2 may select the sub-slot level resources in the same resource pool as that of UE-1. In the example shown in FIG. 6, the sub-slot pattern used by UE-2 may follow the one defined in FIG. 4. In the case of a high load in the RP, the resources selected by UE-2 may partially or fully overlap the resources selected by UE-1. For example, in FIG. 6, the UE-2 may select symbols #6 to #8 within SL Slot #m (i.e., labeled as SS #2) in the time domain and sub-channels SCh #0 to SCh #3 in the frequency domain.

Consequently, simultaneous transmissions from UE-1 and UE-2 on the selected resources (e.g., SS #2 in the time domain and SCh #2 to SCh #3 in the frequency domain) will result in resource collision. If the traffic from UE-2 has a higher priority than that from UE-1, the transmission from UE-2 is preempting the transmission from UE-1. In such cases, the UE-2 is required to indicate to UE-1 the pre-emption or resource collision status, e.g., by using an SL indicator (SL-I). Then, how to indicate the pre-emption or resource collision status by the SL-I and when to transmit the SL-I need to be addressed. The SL-I may also be referred to as SL pre-emption indicator (SL-PI), SL resource collision indicator, SL cancellation indicator, or the like.

Currently, since only a slot level transmission under resource allocation mode 2 is supported for a sidelink, resource allocation and indication methods are needed to support coexistence of slot level transmission and sub-slot level transmission in one RP under resource allocation mode 2. In other words, when different time intervals (e.g., slot level and sub-slot level) exist in the same resource pool, how to support multiplexing of resource allocation results determined in different time intervals under resource allocation mode 2 needs to be solved.

Given the above, embodiments of the present application provide improved solutions for resource allocation in SL communication, which provides several methods regarding the SL-I design (including but not limited to the signaling, the structure of resources, and the procedures associated with SL-I) for resource allocation mode 2. Accordingly, embodiments of the present application can support multiplexing of resource allocation results determined in different time intervals under resource allocation mode 2, thereby achieving the coexistence of sub-slot level sidelink transmission and slot level sidelink transmission under resource allocation mode 2. More details on embodiments of the present application will be illustrated in the following text in combination with the appended drawings.

FIG. 7 illustrates an exemplary flowchart of a method for resource allocation according to some embodiments of the present application. Embodiments of FIG. 7 provide resource allocation methods for resource allocation mode 2. The method illustrated in FIG. 7 may be performed by a UE (e.g., UE 101a or UE 101b in FIG. 1) or other apparatus with the like functions.

In step 701, the UE may obtain configuration information, e.g., based on configuration or pre-configuration. Step 701 is an optional step and may not occur in some embodiments of the present application.

In some embodiments of the present application, the configuration information may be configured per RP (e.g., included in a resource pool configuration associated with an RP). In such embodiments, the configuration information may be associated with the RP and may indicate at least one of: only slot level SL transmission is enabled in the RP; only sub-slot level SL transmission is enabled in the RP; or both slot level SL transmission and sub-slot level SL transmission are enabled in the RP.

In some other embodiments of the present application, the configuration information may be configured per zone (e.g., included in a zone configuration associated with a zone). In such embodiments, the configuration information may be associated with the zone and may indicate at least one of: only slot level SL transmission is enabled in the zone; only sub-slot level SL transmission is enabled in the zone; or both slot level SL transmission and sub-slot level SL transmission are enabled in the zone. In such embodiments, since the zone configuration may include at least one RP configuration for at least one RP included in the zone, the configuration information associated with the zone may also be associated with the at least one RP in the zone. Thus, the configuration information may indicate at least one of: only slot level SL transmission is enabled in the at least one RP in the zone; only sub-slot level SL transmission is enabled in the at least one RP in the zone; or both slot level SL transmission and sub-slot level SL transmission are enabled in the at least one RP in the zone.

In some embodiments of the present application, obtaining the configuration information based on configuration may refer to the configuration information is transmitted by a BS to the UE via a signaling, e.g., a system information block (SIB), a master information block (MIB), a radio resource control (RRC) signaling, a MAC CE, or downlink control information (DCI), such that the UE may receive the configuration information from the BS. In an embodiment of the present application, obtaining the configuration information based on configuration may apply to the scenario where the UE is in coverage of a network.

In some other embodiments of the present application, obtaining the configuration information based on pre-configuration may refer to the configuration information may be hard-wired into the UE or stored on a subscriber identity module (SIM) or universal subscriber identity module (USIM) card for the UE, such that the UE may obtain the configuration information within the UE. In an embodiment of the present application, obtaining the configuration information based on pre-configuration may apply to the scenario where the UE is out of coverage of the network.

In step 702, the UE may obtain SL-I configuration information associated with an RP, e.g., based on configuration or pre-configuration. Step 702 may occur before, after, or concurrently with step 701 in the case that step 701 exists. The RP may be one of the PR(s) associated with the configuration information obtained in step 701.

In some embodiments of the present application, the SL-I configuration information may be configured per resource pool (e.g., included in a resource pool configuration associated with the RP). In such embodiments, the SL-I configuration information may be associated with the RP.

In some other embodiments of the present application, the SL-I configuration information may be configured per zone (e.g., included in a zone configuration associated with a zone). In such embodiments, since the zone configuration may include at least one RP configuration for at least one RP included in the zone, the SL-I configuration information configured for a zone may also be associated with the at least one RP in the zone.

The SL-I configuration information may indicate at least one of: a structure of resource(s) available for SL-I transmission; an association between the resource(s) available for SL-I transmission and resource(s) for corresponding SL transmission(s); or a priority threshold.

In some embodiments of the present application, obtaining the SL-I configuration information based on configuration may refer to the SL-I configuration information is transmitted by a BS to the UE via a signaling, e.g., a system information block (SIB), a master information block (MIB), a radio resource control (RRC) signaling, a MAC CE, or downlink control information (DCI), such that the UE may receive the SL-I configuration information from the BS. In an embodiment of the present application, obtaining the SL-I configuration information based on configuration may apply to the scenario where the UE is in coverage of a network.

In some other embodiments of the present application, obtaining the SL-I configuration information based on pre-configuration may refer to the SL-I configuration information may be hard-wired into the UE or stored on a SIM or USIM card for the UE, such that the UE may obtain the SL-I configuration information within the UE. In an embodiment of the present application, obtaining the SL-I configuration information based on pre-configuration may apply to the scenario where the UE is out of coverage of the network.

According to some embodiments of the present application, the SL-I configuration information may include at least one of the following information to indicate the structure of the resource(s) available for SL-I transmission (e.g., in the time domain):
a sub-slot pattern (e.g., a sub-slot pattern shown in FIG. 3 or FIG. 4) or a slot pattern (e.g., a slot pattern (a) or slot pattern (b) as shown in FIG. 2, or a slot pattern dedicated for SL-I transmission) for SL-I transmission; or
half-symbol(s) (e.g., half-symbol(s) for extra indication shown in FIG. 3 or FIG. 4, or half-symbol(s) in a slot pattern dedicated for SL-I transmission) or symbol(s) (e.g., symbol(s) included in PSFCH of slot pattern (b) shown in FIG. 2, or symbol(s) included in PSFCH of the sub-slot pattern shown in FIG. 3) for SL-I transmission.

According to some embodiments of the present application, the SL-I configuration information may include at least one of the following information to indicate the structure of the resource(s) available for SL-I transmission (e.g., in the frequency domain and/or in the code domain):
sub-channel(s) in each half-symbol or each symbol for SL-I transmission;
a number of PRBs in each sub-channel in each half-symbol or each symbol for SL-I transmission;
a number of PRB sets in each sub-channel in each half-symbol or each symbol for SL-I transmission;
at least one sequence type (e.g., Zadoff-Chu sequence, pseudo random sequence, Gold sequence, etc.) used for SL-I transmission; or
at least one code used for SL-I transmission.

According to some embodiments of the present application, the SL-I configuration information includes the following information to indicate the association between the resource(s) available for SL-I transmission and the resource(s) for the corresponding SL transmission(s): an association between a first group of indexes associated with the resource(s) available for SL-I transmission and a second group of indexes associated with the resource(s) for the corresponding SL transmission(s), wherein the first group of indexes includes at least one of: SL slot index(es) associated with the resource(s) available for SL-I transmission, sub-slot index(es) associated with the resource(s) available for SL-I transmission, sub-chancel index(es) associated with the resource(s) available for SL-I transmission, PRB set index(es) associated with the resource(s) available for SL-I transmission, PRB index(es) associated with the resource(s) available for SL-I transmission, code index(es) associated with the resource(s) available for SL-I transmission, or available resource index(es) associated with the resource(s) available for SL-I transmission; and wherein the second group of indexes includes at least one of: SL slot index(es) associated with the resource(s) for the corresponding SL transmission(s); sub-slot index(es) associated with the resource(s) for the corresponding SL transmission(s); or sub-chancel index(es) associated with the resource(s) for the corresponding SL transmission(s).

As stated above, according to some embodiments of the present application, the SL-I transmission may use half-symbols. Then, the resource(s) for SL-I transmission may be categorized into the following three options depending on (1) whether half-symbol(s) in a sub-slot pattern for SL transmission or in a slot pattern dedicated for SL-I transmission are used and (2) whether resource(s) available for SL transmission or resource(s) dedicated for SL-I transmission are used:
1.1. Half-symbol(s) in a sub-slot pattern and available resource(s) for SL transmission are used for SL-I transmission.
1.2. Half-symbol(s) in a slot pattern dedicated for SL-I transmission and resource(s) dedicated for SL-I transmission are used for SL-I transmission.
1.3. Half-symbol(s) in a sub-slot pattern for SL transmission and resource(s) dedicated for SL-I transmission are used for SL-I transmission.

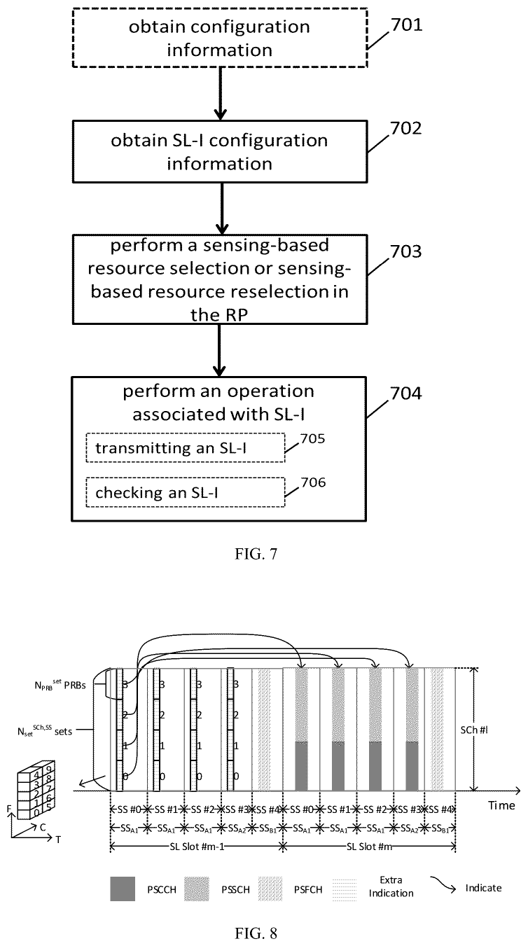

FIG. 8 illustrates exemplary resources for SL-I transmission and corresponding SL transmission according to some embodiments of the present application, where the aforementioned option 1.1 is adopted. In the example of FIG. 8, half-symbol(s) in SL slot #m−1 is used for SL-I transmission to indicate corresponding SL transmission(s) in SL slot #m. The SL transmission(s) in SL slot #m may be sub-slot level SL transmission(s) (as shown in FIG. 8) or slot level SL transmission(s).

The SL-I configuration information associated with the resources for SL-I transmission as illustrated in FIG. 8 may include information to indicate the resources for SL-I transmission in the time domain.

In some embodiments, the information may include a sub-slot pattern for SL-I transmission. In the example of FIG. 8, the sub-slot pattern used for SL-I transmission may be that shown in FIG. 3. The sub-slot pattern may be represented by a sub-slot pattern index in the information.

Alternatively or additionally, the information may include half-symbol(s) used for SL-I transmission. In the example of FIG. 8, there are four half-symbols in a slot used for SL-I transmission, and each half-symbol of the four half-symbols may be a half-symbol for extra indication as shown in FIG. 3, which is included in a corresponding sub-slot of the slot as shown in FIG. 3. Consequently, in the information, each half-symbol may be represented by an index (e.g., Iₛₛ^{SL-1}) of the corresponding sub-slot in the sub-slot pattern. For example, the four half-symbols in FIG. 8 may be represented by SS #0, SS #1, SS #2, and SS #3, respectively, wherein SS #0, SS #1, SS #2, and SS #3 are indexes of the four corresponding sub-slots. FIG. 8 omits some half-symbols and symbols in the sub-slot pattern for simplicity and clarity.

The SL-I configuration information associated with the resources for SL-I transmission as illustrated in FIG. 8 may also include information to indicate the resources for SL-I transmission in the frequency domain.

In some embodiments of the present application, the information may include sub-channel(s) in each half-symbol for SL-I transmission. Each sub-channel may be represented by a sub-channel index in the information. In the example of FIG. 8, the sub-channel for SL-I transmission is SCh #1.

Alternatively or additionally, the information may include a number of PRBs (e.g., N_{PRB}^{SCh,SS}) in each sub-channel in each half-symbol for SL-I transmission. In some embodiments of the present application, the PRB(s) in each sub-channel in each half-symbol available for SL-I transmission may be indicated by using a bitmap, a look up table, and so on, which may implicitly indicate the number of the PRB(s).

Alternatively or additionally, the information may include a number of PRB sets (e.g., Nₛₑₜ^{SCh,SS}) in each sub-channel in each half-symbol for SL-I transmission. In some embodiments of the present application, the number of PRB sets Nₛₑₜ^{SCh,SS} may be determined by considering the number of SL transmissions to be associated. For example, assuming that the SL transmissions are sub-slot level SL transmissions, then the number of PRB sets may be equal to the number of sub-slots for the sub-slot level SL transmissions in one SL slot, and thus each PRB set may be associated with a sub-slot for a sub-slot level SL transmission, respectively.

For example, assuming that N_{PRB}^{SCh,SS} PRBs within one sub-channel in one sub-slot are available for SL-I transmission and the number of PRB sets is Nₛₑₜ^{SCh,SS}, then the N_{PRB}^{SCh,SS} PRBs may be divided into Nₛₑₜ^{SCh,SS} PRB sets. Each PRB set may include N_{PRB}^{set} (e.g., N_{PRB}^{set}=floor (N_{PRB}^{SCh,SS}/Nₛₑₜ^{SCh,SS})) PRBs. Each PRB set can be indicated by an index (e.g., Iₛₑₜ^{SCh,SS}), and each PRB included in a PRB set, may be indicated by a PRB index (e.g., I_{PRB}^{Set}).

The SL-I configuration information associated with the resources for SL-I transmission as illustrated in FIG. 8 may also include information to indicate the resources for SL-I transmission in the code domain.

In some embodiments of the present application, the information may include at least one code used for SL-I transmission. In the case that a Zadoff-Chu sequence is used, for example, a code may refer to a cyclic shift for each PRB and may be indicated by a code index I_{C}.

In some embodiments of the present application, different codes are introduced with the aims of increasing available resources for each PRB. For example, different codes allow at least one of the following purposes: providing more priorities (e.g., each code is associated with a priority), supporting simultaneous transmission and reception over multiple UE (e.g., each code is associated with a UE), or even supporting other purposes in addition to SL-I transmission. In the example of FIG. 8, the codes used for SL-I transmission may include 2 cyclic shifts (e.g., Q=2) for each PRB.

As an example, in FIG. 8, it is assumed that N_{PRB}^{SCh,SS}=20 and Nₛₑₜ^{SCh,SS}=4. Then, the 20 PRBs in SCh #1 in a half-symbol (included in SS #0, SS #1, SS #2, or SS #3) are divided into 4 PRB sets which are labeled as resource set #0 to resource set #3 (also referred to as set #0 to set #3), and each PRB set may include 5 PRBs which are labeled as (or indicated by) PRB #0 to PRB #4.

Moreover, it is assumed that there are Q=2 cyclic shifts (which are indexed as code #0 and code #1) for each PRB. As a result, the resource(s) for SL-I transmission in each set have been doubled compared to the case of Q=1.

In some embodiments of present application, within each set, the available resources may be indicated by a PRB index I_{PRB}^{Set} and a code index I_{C}. In some other embodiments of the present application, the indexes (e.g., I_{AR}^{Set}) for available resources within each set may be first increased with the PRB index until reaching the number of available PRBs in each set and then increased with the code index. In the example of FIG. 8, each set may include 10 available resources. The first available resource may be indicated by a PRB index #0 and code index #0, or by an available resource index #0. The second available resource may be indicated by a PRB index #1 and code index #0, or by an available resource index #1. The third available resource may be indicated by a PRB index #2 and code index #0, or by an available resource index #2. The fourth available resource may be indicated by a PRB index #3 and code index #0, or by an available resource index #3. The fifth available resource may be indicated by a PRB index #4 and code index #0, or by an available resource index #4. The sixth available resource may be indicated by a PRB index #0 and code index #1, or by an available resource index #5. The seventh available resource may be indicated by a PRB index #1 and code index #1, or by an available resource index #6. The eighth available resource may be indicated by a PRB index #2 and code index #1, or by an available resource index #7. The ninth available resource may be indicated by a PRB index #3 and code index #1, or by an available resource index #8. The tenth available resource may be indicated by a PRB index #4 and code index #1, or by an available resource index #9.

In some embodiments of the present application, the information indicating the structure of resources for SL-I transmission may include at least one sequence type used for SL-I transmission. Each sequence type may be indicated by a sequence type index.

In some embodiments of the present application, if more resource(s) for SL-I transmission are needed in SL slot #m−1, in addition to SS #0 as shown in FIG. 8, one or more of SS #1 to SS #3 can also be used. The available resource(s) in SS #1 to #3 can be structured by using the same methods as those used in SS #0.

The SL-I configuration information associated with the resources for SL-I transmission as illustrated in FIG. 8 may further include information to indicate the association between the resource(s) available for SL-I transmission and the resource(s) for the corresponding SL transmission(s).

In some embodiments of the present application, the information may include an association between a first group of indexes associated with the resource(s) available for SL-I transmission and a second group of indexes associated with the resource(s) for the corresponding SL transmission(s).

The first group of indexes includes at least one of:
SL slot index(es) (e.g., Iₛ^{SL-1}) associated with the resource(s) available for SL-I transmission,
sub-slot index(es) (e.g., Iₛₛ^{SL-1}) associated with the resource(s) available for SL-I transmission,
sub-chancel index(es) (e.g., I_{sch}^{SL-I}) associated with the resource(s) available for SL-I transmission,
PRB set index(es) (e.g., Iₛₑₜ^{SCh,SS}) associated with the resource(s) available for SL-I transmission,
PRB index(es) (e.g., I_{PRB}^{Set}) associated with the resource(s) available for the SL-I transmission,
code index(es) (e.g., I_{C}) associated with the resource(s) available for the SL-I transmission, or
available resource index(es) (e.g., I_{AR}^{Set}) associated with the resource(s) available for the SL-I transmission.

The second group of indexes includes at least one of:
SL slot index(es) (e.g., Iₛ^{SL}) associated with the resource(s) for the corresponding SL transmission(s);
sub-slot index(es) (Iₛₛ^{SL}) associated with the resource(s) for the corresponding SL transmission(s); or
sub-chancel index(es) (I_{sch}^{SL}) associated with the resource(s) for the corresponding SL transmission(s).

In some embodiments of the present application, the association between SL slot index(es) associated with the resource(s) available for SL-I transmission and SL slot index(es) associated with the resource(s) for the corresponding SL transmission(s) may be indicated by a time gap (e.g., TGs) between a slot including the resource(s) available for SL-I transmission and a slot including the resource(s) for the corresponding SL transmission(s). In the example illustrated in FIG. 8, TGₛ=1 slot, which means that for the SL transmission in slot #m, the corresponding SL-I may be transmitted in slot #m−1.

In some embodiments of the present application, the time gap may be in units of slot. In some embodiments of the present application, the time gap may be configured by considering at least one processing time requirement. That is, enough processing time is needed for a UE receiving SL-I to perform collision avoidance in response to a resource collision occurring, and thus the time gap may be configured as a value larger than or equal to the processing time needed by the UE. In some embodiments of the present application, the time gap may be configured by considering latency budget for a traffic such that the time gap is short enough for a UE to transmit an SL-I indicating the reserved resource(s) for the intended latency-critical traffic.

Alternatively or additionally, the information indicating the association may include a mapping relationship between sub-channel(s) in each half-symbol for SL-I transmission and at least one sub-channel for the corresponding SL transmission(s). In some embodiments of the present application, the mapping relationship may be indicated by sub-channel index(es) of the sub-channel(s) for SL-I transmission, sub-channel index(es) of the at least one sub-channel for the corresponding SL transmission(s), and their mapping. In some embodiments of the present application, the mapping relationship may be indicated by a sub-channel gap between the sub-channel for SL-I transmission and the sub-channel for the corresponding SL transmission.

In the example of FIG. 8, the mapping relationship may include that SCh #1 for SL-I transmission is associated with (or maps to) SCh #1 for the corresponding SL transmission, or the sub-channel gap is 0, which means that the SL-I transmitted in SCh #1 is used to indicate an SL transmission in SCh #1.

Alternatively or additionally, the information indicating the association may include a mapping relationship between the resource set(s) for SL-I transmission and one or more sub-slots for the corresponding SL transmission(s), wherein each resource set of the resource set(s) is associated with a sub-slot of the one or more sub-slots.

In some embodiments of the present application, the association between the first group of indexes associated with the resource(s) available for SL-I transmission and the second group of indexes associated with the resource(s) for the corresponding SL transmission(s) may be indicated by principles. In an embodiment of the present application, the principles may also be implemented by a look up table.

For example, in FIG. 8, the principles include that the resource sets for SL-I transmission in SS #0 are associated with the sub-slots for sub-slot level SL transmission with one-to-one mapping. Then, the mapping relationship may include that PRB set #0 to #3 in SS #0 in SL slot #m−1 are associated with SS #0 to SS #3 in SL slot #m, respectively. For example, the SL-I transmitted in PRB set #0 in SS #0 in SL slot #m−1 may be used to indicate an intended SL transmission in SS #0 in SL slot #m.

In the example of FIG. 8, different resources in each resource set may correspond to different priorities or a same priority of an SL transmission associated with the resource set. In some embodiments of the present application, the priority of SL transmission is indicated by at least one of: a sequence type associated with the SL-I; a PRB index associated with the SL-I; a code index associated with the SL-I; or an available resource index associated with the SL-I.

Taking PRB set #0 in SS #0 in SL slot #m−1 as an example, it may include 10 available resources for transmitting an SL-I as shown in FIG. 8, and the SL-I may indicate an SL transmission in SS #0 in SL slot #m. In the case that the priority is indicated by a sequence type, SL-Is transmitted using the same sequence type may indicate SL transmissions with the same priority no matter in which resource of PRB set #0 in SS #0 in SL slot #m−1 the SL-Is are transmitted. In the case that the priority is indicated by a PRB index, the 10 available resources of PRB set #0 in SS #0 in SL slot #m−1 may correspond to up to five different priorities because PRB set #0 includes 5 PRBs. In such case, the SL-I transmitted in one of PRB #0, PRB #1, PRB #2, PRB #3, and PRB #4 may indicate an SL transmission with a corresponding priority among the five different priorities.

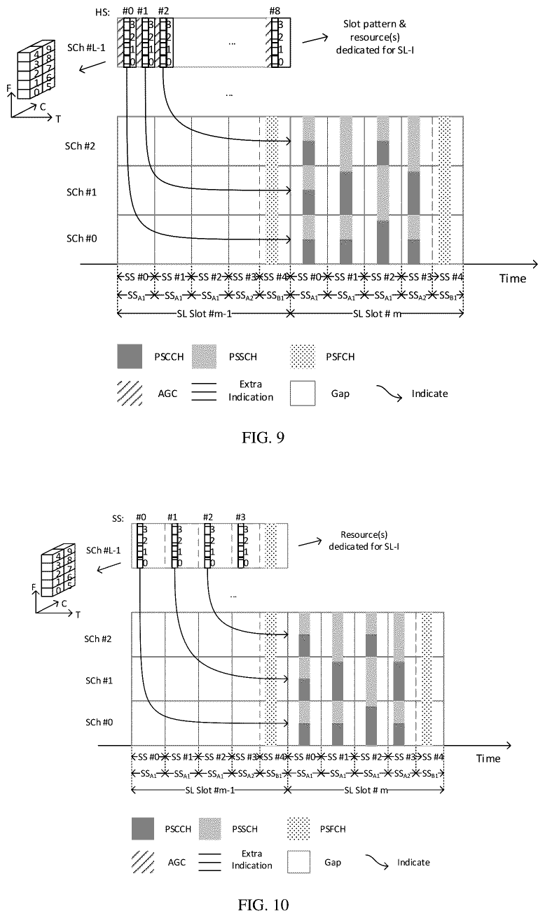

FIG. 9 illustrates exemplary resources for SL-I transmission and corresponding SL transmission according to some other embodiments of the present application, where the aforementioned option 1.2 is adopted. In the example of FIG. 9, half-symbol(s) in SL slot #m−1 is used for SL-I transmission to indicate corresponding SL transmission(s) in SL slot #m. The SL transmission(s) in SL slot #m may be sub-slot level SL transmission(s) (as shown in FIG. 9) or slot level SL transmission(s).

The SL-I configuration information associated with the resources for SL-I transmission as illustrated in FIG. 9 may include information to indicate the resources for SL-I transmission in the time domain.

In some embodiments, the information may include a slot pattern. In the example of FIG. 9, the slot pattern used for SL-I transmission may be a slot pattern dedicated for SL-I transmission. The slot pattern may be represented by a slot pattern index in the information.

Alternatively or additionally, the information may include half-symbol(s) used for SL-I transmission. In some embodiments of the present application, each half-symbol for SL-I transmission may be a half-symbol for extra indication defined in the slot pattern. In the example of FIG. 9, there are eight half-symbols in a slot used for SL-I transmission, which are labeled as (or indicated by) HS #0, HS #1, HS #2, HS #3, HS #5, HS #6, HS #7, and HS #8, respectively.

The SL-I configuration information associated with the resources for SL-I transmission as illustrated in FIG. 9 may also include information to indicate the resources for SL-I transmission in the frequency domain.

In some embodiments of the present application, the information may include sub-channel(s) in each half-symbol for SL-I transmission. In the example of FIG. 8, it is assumed that there are L sub-channels in a resource pool (labelled as SCh #0 to SCh #L−1), and the sub-channel for SL-I transmission is SCh #L−1.

Alternatively or additionally, the information may include a number of PRBs in each sub-channel in each half-symbol for SL-I transmission. Alternatively or additionally, the information may include a number of PRB sets in each sub-channel in each half-symbol for SL-I transmission. All the methods, principles, and definitions for determining the number of PRBs in each half-symbol, the number of PRB sets in each half-symbol, and the structure of PRBs in each set in each half-symbol described with respect to FIG. 8 may also apply for determining the number of PRBs, the number of PRB sets, and the structure of PRBs in each set in the example illustrated in FIG. 9.

The SL-I configuration information associated with the resources for SL-I transmission as illustrated in FIG. 9 may also include information to indicate the resources for SL-I transmission in the code domain.

In some embodiments of the present application, the information may include at least one code used for SL-I transmission. In the case that a Zadoff-Chu sequence is used, for example, a code may refer to a cyclic shift for each PRB and may be indicated by a code index I_{C}.

In some embodiments of the present application, the information indicating the structure of resources for SL-I transmission may include at least one sequence type used for SL-I transmission. All the methods, principles, and definitions for the sequence type and code described with respect to FIG. 8 may also apply for the sequence type and code in the example illustrated in FIG. 9.

As an example, in FIG. 9, it is assumed that 20 PRBs and 4 PRB sets in each sub-channel in each half-symbol are configured for SL-I transmission. Then, in SCh #L−1 in each half-symbol, all the 20 PRBs are grouped into 4 PRB sets which are labeled as resource set #0 to resource set #3 (also referred to as set #0 to set #3), and the number of PRBs in each PRB set is 5.

Moreover, it is assumed that there are Q=2 cyclic shifts (which are indexed as code #0 and code #1) for each PRB. In the example of FIG. 9, each PRB set or resource set may include 10 available resources, and the available resource indexes of the 10 available resources are #0 to #9.

The SL-I configuration information associated with the resources for SL-I transmission as illustrated in FIG. 9 may further include information to indicate the association between the resource(s) available for SL-I transmission and the resource(s) for the corresponding SL transmission(s).

In some embodiments of the present application, the information indicating the association may include a time gap (e.g., TGs) between a slot including the resource(s) available for SL-I transmission and a slot including the resource(s) for the corresponding SL transmission(s). In the example illustrated in FIG. 9, TGs=1 slot, which means that for the SL transmission in slot #m, the corresponding SL-I may be transmitted in slot #m−1.

Alternatively or additionally, the information indicating the association may include a mapping relationship between sub-channel(s) in each half-symbol for SL-I transmission and at least one sub-channel for the corresponding SL transmission(s). In some embodiments of the present application, the mapping relationship may be indicated by sub-channel index(es) of the sub-channel(s) for SL-I transmission, sub-channel index(es) of the at least one sub-channel for the corresponding SL transmission(s), and their mapping. In some embodiments of the present application, the mapping relationship may be indicated by a sub-channel gap between the sub-channel for SL-I transmission and the sub-channel for the corresponding SL transmission. In the example of FIG. 9, the mapping relationship may include that SCh #L−1 for SL-I transmission is associated with SCh #0 to SCh #2 for corresponding SL transmission(s), which means that the SL-I transmitted in SCh #L−1 is used to indicate an SL transmission in SCh #0 to SCh #2.

Alternatively or additionally, the information indicating the association may include a mapping relationship between the half-symbol(s) for SL-I transmission and at least one sub-channel for the corresponding SL transmission(s), wherein each half-symbol is associated with a sub-channel of the at least one sub-channel for the corresponding SL transmission(s). In the example of FIG. 9, the mapping relationship may include that HS #0 is associated with SCh #0, HS #1 is associated SCh #1, and HS #2 is associated SCh #2.

Alternatively or additionally, the information indicating the association may include a mapping relationship between the resource set(s) for SL-I transmission and one or more sub-slots for the corresponding SL transmission(s), wherein each resource set of the resource set(s) is associated with a sub-slot of the one or more sub-slots. All the methods, principles, and definitions for mapping relationship between the resource set(s) for SL-I transmission and one or more sub-slots for the corresponding SL transmission(s) described with respect to FIG. 8 may also apply for the mapping relationship in the example illustrated in FIG. 9. In the example of FIG. 9, the mapping relationship may include that PRB set #0 to PRB set #3 in each half-symbol are associated with sub-slot #0 to sub-slot #3, respectively.

Based on the above mapping relationships, a UE may determine that: PRB set #0 to PRB set #3 in HS #0 are associated with SCh #0 in SS #0, SS #1, SS #2, and SS #3, respectively; PRB set #0 to PRB set #3 in HS #1 are associated with SCh #1 in SS #0, SS #1, SS #2, and SS #3, respectively; and PRB set #0 to PRB set #4 in HS #2 are associated with SCh #2 in SS #0, SS #1, SS #2, and SS #3, respectively. For example, if a UE intends to indicate an SL transmission in SCh #2 in SS #0, then the UE may transmit the corresponding SL-I in PRB set #0 in HS #2.

In the example of FIG. 9, different resources in each resource set may correspond to different priorities or a same priority of an SL transmission associated with the resource set. All the methods, principles, and definitions for determining the priority described with respect to FIG. 8 may also apply for determining the priority in the example illustrated in FIG. 9.

FIG. 10 illustrates exemplary resources for SL-I transmission and corresponding SL transmission according to some other embodiments of the present application, where the aforementioned option 1.3 is adopted. In the example of FIG. 10, half-symbol(s) in SL slot #m−1 is used for SL-I transmission to indicate corresponding SL transmission(s) in SL slot #m. The SL transmission(s) in SL slot #m may be sub-slot level SL transmission(s) (as shown in FIG. 10) or slot level SL transmission(s).

The differences between the examples illustrated in FIG. 9 and FIG. 10 only lie in that:
The SL-I configuration information associated with the resources for SL-I transmission as illustrated in FIG. 10 includes a sub-slot pattern for SL transmission. For example, the sub-slot pattern in FIG. 10 may be the same as that in FIG. 3.
The SL-I configuration information associated with the resources for SL-I transmission as illustrated in FIG. 10 includes four half-symbols in a slot used for SL-I transmission, which are labeled as (or indicated by) HS #0, HS #1, HS #2, and HS #3. In some embodiments of the present application, each half-symbol may be included in a corresponding sub-slot of the slot as shown in FIG. 3, and thus the half-symbols in FIG. 10 may be indicated by the indexes of the corresponding sub-slots, e.g., SS #0, SS #1, SS #2, and SS #3, respectively.

Except for the above differences, other information included in the SL-I configuration information associated with the resources for SL-I transmission as illustrated in FIG. 10 may be the same as that included in the SL-I configuration information associated with the resources for SL-I transmission as illustrated in FIG. 9. Consequently, all the definitions, principle, and methods for determining the structure of resources for SL-I transmission and the association between the resource(s) available for SL-I transmission and resource(s) for corresponding SL transmission(s) described with respect to FIG. 9 may apply for the example illustrated in FIG. 10.

As stated above, according to some other embodiments of the present application, the SL-I transmission may use symbol(s). Then, the resource(s) for SL-I transmission may be categorized into the following four options depending on (1) whether symbol(s) in a sub-slot pattern or in a slot pattern are used and (2) whether resource(s) available for SL transmission or resource(s) dedicated for SL-I transmission are used.
2.1. Symbol(s) in a sub-slot pattern and available resource(s) for SL transmission are used for SL-I transmission.
2.2. Symbol(s) in a sub-slot pattern and resource(s) dedicated for SL-I transmission are used for SL-I transmission.
2.3. Symbol(s) in a slot pattern and available resource(s) for SL transmission are used for SL-I transmission.
2.4. Symbol(s) in a slot pattern and resource(s) dedicated for SL-I transmission are used for SL-I transmission.

According to some embodiments of the present application, the symbol(s) for SL-I transmission may be included in a PSFCH.

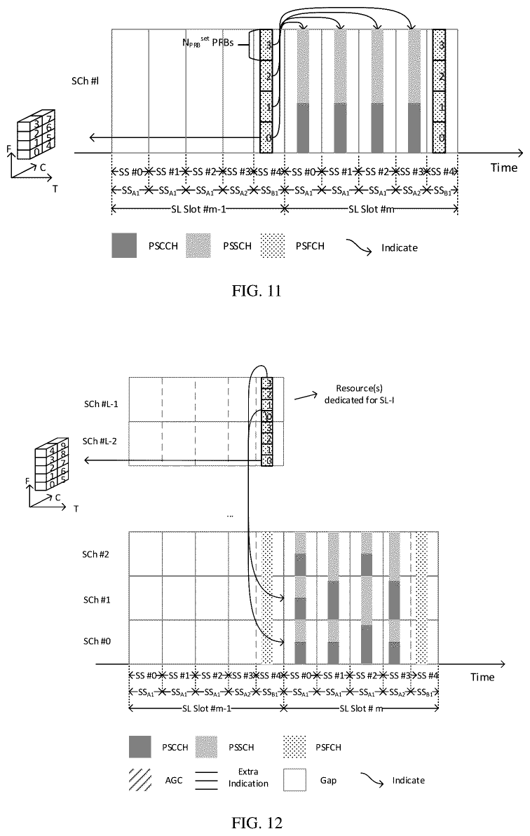

FIG. 11 illustrates exemplary resources for SL-I transmission and corresponding SL transmission according to some embodiments of the present application, where the aforementioned option 2.1 is adopted. In the example of FIG. 11, a symbol in SL slot #m−1 is used for SL-I transmission to indicate corresponding SL transmission(s) in SL slot #m. The SL transmission(s) in SL slot #m may be sub-slot level SL transmission(s) (as shown in FIG. 11) or slot level SL transmission(s).

The SL-I configuration information associated with the resources for SL-I transmission as illustrated in FIG. 11 may include information to indicate the resources for SL-I transmission in the time domain.

In some embodiments, the information may include a sub-slot pattern for SL-I transmission. In the example of FIG. 11, the sub-slot pattern used for SL-I transmission may be that shown in FIG. 3. The sub-slot pattern may be represented by a sub-slot pattern index in the information.

Alternatively or additionally, the information may include symbol(s) used for SL-I transmission. The symbol(s) used for SL-I transmission may be indicated by symbol index(es). In the example of FIG. 11, the symbol(s) used for SL-I transmission may be one symbol (e.g., symbol #12 as shown in FIG. 3) in PSFCH. Alternatively, the symbol(s) used for SL-I transmission may be indicated by sub-slot index(es). In the example of FIG. 11, the symbol(s) used for SL-I transmission may be one symbol in PSFCH, i.e., the one symbol is included in SS #4 as shown in FIG. 3, and thus, the symbol used for SL-I transmission may be indicated by SS #4.

The SL-I configuration information associated with the resources for SL-I transmission as illustrated in FIG. 11 may also include information to indicate the resources for SL-I transmission in the frequency domain.

In some embodiments of the present application, the information may include sub-channel(s) in each symbol for SL-I transmission. Each sub-channel may be represented by a sub-channel index in the information. In the example of FIG. 11, the sub-channel for SL-I transmission is SCh #1.

Alternatively or additionally, the information may include a number of PRBs (e.g., N_{PRB}^{SCh,SS}) in each sub-channel in each symbol for SL-I transmission. In some embodiments of the present application, the PRBs in each sub-channel in each symbol available for SL-I transmission may be indicated by using a bitmap, a look up table, and so on, which may implicitly indicate the number of the PRB(s).

Alternatively or additionally, the information may include a number of PRB sets (e.g., Nₛₑₜ^{SCh,SS}) in each sub-channel in each symbol for SL-I transmission. In some embodiments of the present application, the number of PRB sets Nₛₑₜ^{SCh,SS} may be determined by considering the number of SL transmissions to be associated. For example, assuming that the SL transmissions are sub-slot level SL transmissions, then the number of PRB sets may be equal to the number of sub-slots for the sub-slot level SL transmissions in one SL slot, and thus each PRB set may be associated with a sub-slot for a sub-slot level SL transmission, respectively.

The SL-I configuration information associated with the resources for SL-I transmission as illustrated in FIG. 11 may also include information to indicate the resources for SL-I transmission in the code domain.

In some embodiments of the present application, the information may include at least one code used for SL-I transmission. In the case that Zadoff-Chu sequence is used, for example, a code may refer to a cyclic shift for each PRB. In some embodiments of the present application, the information may include at least one sequence type used for SL-I transmission. All the methods, principles, and definitions for the sequence type and code described with respect to FIG. 8 may also apply for the sequence type and code in the example illustrated in FIG. 11.

As an example, in FIG. 11, it is assumed that N_{PRB}^{SCh,SS}=20 and Nₛₑₜ^{SCh,SS}=4. Then, the 20 PRBs in SCh #1 in symbol #12 are divided into 4 PRB sets (which are labeled as PRB set #0 to PRB set #3), and each PRB set may include 5 PRBs which are labeled as (or indicated by) PRB #0 to PRB #4.

Moreover, it is assumed that there are Q=2 cyclic shifts (which are labeled as code #0 and code #1) for each PRB. Then, each set may include 10 available resources, and the available resource indexes of the 10 available resources are #0 to #9.

The SL-I configuration information associated with the resources for SL-I transmission as illustrated in FIG. 11 may further include information to indicate the association between the resource(s) available for SL-I transmission and the resource(s) for the corresponding SL transmission(s).

In some embodiments of the present application, the information may include an association between a first group of indexes associated with the resource(s) available for SL-I transmission and a second group of indexes associated with the resource(s) for the corresponding SL transmission(s).

The first group of indexes includes at least one of:
SL slot index(es) (e.g., Iₛ^{SL-1}) associated with the resource(s) available for SL-I transmission,
sub-slot index(es) (e.g., Iₛₛ^{SL-1}) associated with the resource(s) available for SL-I transmission,
sub-chancel index(es) (e.g., I_{sch}^{SL-1}) associated with the resource(s) available for SL-I transmission,
PRB set index(es) (e.g., Iₛₑₜ^{SCh,SS}) associated with the resource(s) available for SL-I transmission,
PRB index(es) (e.g., I_{PRB}^{Set}) associated with the resource(s) available for SL-I transmission,
code index(es) (e.g., I_{C}) associated with the resource(s) available for SL-I transmission, or
available resource index(es) (e.g., I_{AR}^{Set}) associated with the resource(s) available for SL-I transmission.

The second group of indexes includes at least one of:
SL slot index(es) (e.g., Iₛ^{SL}) associated with the resource(s) for the corresponding SL transmission(s);
sub-slot index(es) (Iₛₛ^{SL}) associated with the resource(s) for the corresponding SL transmission(s); or
sub-chancel index(es) (I_{sch}^{SL}) associated with the resource(s) for the corresponding SL transmission(s).

In some embodiments of the present applicator, the association may be indicated by principles. In an embodiment of the present application, the principles may also be implemented by a look up table.

For example, in FIG. 11, the principles include that PRB resource set #0 to #3 in symbol #12 in SL slot #m−1 are associated with SS #0 to SS #3 in SL slot #m, respectively.

In some other embodiments of the present application, the association between SL slot index(es) associated with the resource(s) available for SL-I transmission and SL slot index(es) associated with the resource(s) for the corresponding SL transmission(s) may be indicated by a time gap (e.g., TGs) between a slot including the resource(s) available for SL-I transmission and a slot including the resource(s) for the corresponding SL transmission(s).

In some embodiments of the present application, the time gap may be in units of slot. In the example in FIG. 11, TGs=1 slot, which means that for the SL transmission in slot #m, the corresponding SL-I may be transmitted in slot #m−1.

Alternatively or additionally, the information indicating the association may include a mapping relationship between sub-channel(s) in each symbol for SL-I transmission and at least one sub-channel for the corresponding SL transmission(s). In some embodiments of the present application, the mapping relationship may be indicated by sub-channel index(es) of the sub-channel(s) for SL-I transmission, sub-channel index(es) of the at least one sub-channel for the corresponding SL transmission(s), and their mapping. In some embodiments of the present application, the mapping relationship may be indicated by a sub-channel gap between the sub-channel for SL-I transmission and the sub-channel for the corresponding SL transmission.

In the example of FIG. 11, the mapping relationship may include that SCh #1 for SL-I transmission is associated with SCh #1 for the corresponding SL transmission, or the sub-channel gap is 0, which means that the SL-I transmitted in SCh #1 is used to indicate an SL transmission in SCh #1.

Alternatively or additionally, the information indicating the association may include a mapping relationship between the resource set(s) for SL-I transmission and one or more sub-slots for the corresponding SL transmission(s), wherein each resource set of the resource set(s) is associated with a sub-slot of the one or more sub-slots.

In the example of FIG. 11, different resources in each resource set may correspond to different priorities or a same priority of an SL transmission associated with the resource set. All the methods, principles, and definitions for determining the priority described with respect to FIG. 8 may also apply for determining the priority in the example illustrated in FIG. 11.

FIG. 12 illustrates exemplary resources for SL-I transmission and corresponding SL transmission according to some other embodiments of the present application, where the aforementioned option 2.2 is adopted. In the example of FIG. 12, a symbol in SL slot #m−1 is used for SL-I transmission to indicate corresponding SL transmission(s) in SL slot #m. The SL transmission(s) in SL slot #m may be sub-slot level SL transmission(s) (as shown in FIG. 12) or slot level SL transmission(s).

The SL-I configuration information associated with the resources for SL-I transmission as illustrated in FIG. 12 may include information to indicate the resources for SL-I transmission in the time domain.

In some embodiments, the information may include a slot pattern. In the example of FIG. 12, the slot pattern used for SL-I transmission may be the same as that in FIG. 4, but is not used for SL-transmissions.

Alternatively or additionally, the information may include symbol(s) used for SL-I transmission. The symbol(s) used for SL-I transmission may be indicated by a symbol index(es). In the example of FIG. 12, the symbol(s) used for SL-I transmission may be one symbol (e.g., symbol #12 as shown in FIG. 3) in PSFCH.

The SL-I configuration information associated with the resources for SL-I transmission as illustrated in FIG. 12 may also include information to indicate the resources for SL-I transmission in the frequency domain.

In some embodiments of the present application, the information may include sub-channel(s) in each symbol for SL-I transmission. In the example of FIG. 12, it is assumed that there are L sub-channels in a resource pool (labelled as SCh #0 to SCh #L−1), and the sub-channels for SL-I transmission is SCh #L−1 and SCh #L−2.

Alternatively or additionally, the information may include a number of PRBs in each sub-channel in each symbol for SL-I transmission. Alternatively or additionally, the information may include a number of PRB sets in each sub-channel in each symbol for SL-I transmission. All the methods, principles, and definitions for determining the number of PRBs in each symbol, the number of PRB sets in each symbol, and the structure of PRBs in each set in each symbol described with respect to FIG. 11 may also apply for determining the number of PRBs, the number of PRB sets, and the structure of PRBs in each set in the example illustrated in FIG. 12.

The SL-I configuration information associated with the resources for SL-I transmission as illustrated in FIG. 9 may also include information to indicate the resources for SL-I transmission in the code domain.

In some embodiments of the present application, the information may include at least one code used for SL-I transmission. In the case that Zadoff-Chu sequence is used, for example, a code may refer to a cyclic shift for each PRB. In some embodiments of the present application, the information may include at least one sequence type used for SL-I transmission. All the methods, principles, and definitions for the sequence type and code described with respect to FIG. 11 may also apply for the sequence type and code in the example illustrated in FIG. 12.

As an example, in FIG. 12, it is assumed that in each sub-channel (e.g. each of SCh #L−2 and SCh #L−1) in each symbol (e.g., symbol #12), there are 20 PRBs and 4 PRB sets configured for SL-I transmission. Then, in SCh #L−2, all the 20 PRBs are grouped into 4 PRB sets which are labeled as resource set #0 to resource set #3 (also referred to as set #0 to set #3), and the number of PRBs in each set is 5. Similarly, in SCh #L−1, all the 20 PRBs are grouped into 4 PRB sets which are labeled as resource set #0 to resource set #3 (also referred to as set #0 to set #3), and the number of PRBs in each PRB set is 5.

Moreover, it is assumed that there are Q=2 cyclic shifts (which are indexed as code #0 and code #1) for each PRB. In the example of FIG. 12, each PRB set or resource set may include 10 available resources, and the available resource indexes of the 10 available resources are #0 to #9.

The SL-I configuration information associated with the resources for SL-I transmission as illustrated in FIG. 12 may further include information to indicate the association between the resource(s) available for SL-I transmission and the resource(s) for the corresponding SL transmission(s).

The information indicating the association may include a time gap (e.g., TGs) between a slot including the resource(s) available for SL-I transmission and a slot including the resource(s) for the corresponding SL transmission(s). In the example illustrated in FIG. 12, TGs=1 slot, which means that for the SL transmission in slot #m, the corresponding SL-I may be transmitted in slot #m−1.

Alternatively or additionally, the information indicating the association may include a mapping relationship between sub-channel(s) in each symbol for SL-I transmission and at least one sub-channel for the corresponding SL transmission(s). In some embodiments of the present application, the mapping relationship may be indicated by sub-channel index(es) of the sub-channel(s) for SL-I transmission, sub-channel index(es) of the at least one sub-channel for the corresponding SL transmission(s), and their mapping. In some embodiments of the present application, the mapping relationship may be indicated by a sub-channel gap between the sub-channel for SL-I transmission and the sub-channel for the corresponding SL transmission. In the example of FIG. 12, the mapping relationship may include that SCh #L−2 for SL-I transmission is associated with SCh #0 for SL transmission(s) and SCh #L−1 for SL-I transmission is associated with SCh #1 for SL transmission(s).

Alternatively or additionally, the information indicating the association may include a mapping relationship between the resource set(s) for SL-I transmission and one or more sub-slots for the corresponding SL transmission(s), wherein each resource set of the resource set(s) is associated with a sub-slot of the one or more sub-slots. All the methods, principles, and definitions for mapping relationship between the resource set(s) for SL-I transmission and one or more sub-slots for the corresponding SL transmission(s) described with respect to FIG. 11 may also apply for the mapping relationship in the example illustrated in FIG. 12. In the example of FIG. 12, the mapping relationship may include that the set #0 to set #3 in each sub-channel in symbol #12 are associated with sub-slot #0 to sub-slot #3, respectively.

Based on the above mapping relationships, a UE may determine that: PRB set #0 to PRB set #3 in SCh #L−2 are associated with SCh #0 in SS #0, SS #1, SS #2, and SS #3, respectively; PRB set #0 to PRB set #4 in SCh #L−1 are associated with SCh #1 in SS #0, SS #1, SS #2, and SS #3, respectively. For example, if a UE intends to indicate an SL transmission in SCh #1 in SS #0, then the UE may transmit the corresponding SL-I in PRB set #0 in SCh #L−1.

In the example of FIG. 12, different resources in each resource set may correspond to different priorities or a same priority of an SL transmission associated with the resource set. All the methods, principles, and definitions for determining the priority described with respect to FIG. 8 may also apply for determining the priority in the example illustrated in FIG. 12.

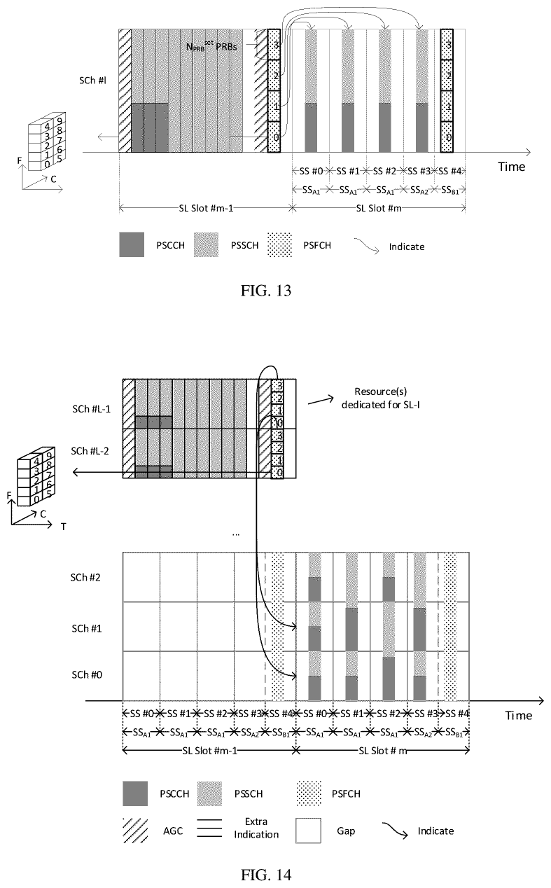

FIG. 13 illustrates exemplary resources for SL-I transmission and corresponding SL transmission according to some other embodiments of the present application, where the aforementioned option 2.3 is adopted. In the example of FIG. 13, a symbol in SL slot #m−1 is used for SL-I transmission to indicate corresponding SL transmission(s) in SL slot #m. The SL transmission(s) in SL slot #m may be sub-slot level SL transmission(s) (as shown in FIG. 13) or slot level SL transmission(s).

The difference between the examples illustrated in FIG. 13 and FIG. 11 only lie in that: the SL-I configuration information associated with the resources for SL-I transmission as illustrated in FIG. 13 includes a slot pattern for SL-I transmission. The slot pattern may be indicated by a slot pattern index. For example, the sub-slot pattern for SL-I transmission illustrated in FIG. 13 may be the same as slot pattern (b) in FIG. 2.

Except for the above difference, other information included in the SL-I configuration information associated with the resources for SL-I transmission as illustrated in FIG. 13 may be the same as that included in the SL-I configuration information associated with the resources for SL-I transmission as illustrated in FIG. 11. Consequently, all the definitions, principle, and methods for determining the structure of resources for SL-I transmission and the association between the resource(s) available for SL-I transmission and resource(s) for corresponding SL transmission(s) described with respect to FIG. 11 may apply for the example illustrated in FIG. 13.

FIG. 14 illustrates exemplary resources for SL-I transmission and corresponding SL transmission according to some other embodiments of the present application, where the aforementioned option 2.4 is adopted. In the example of FIG. 14, a symbol in SL slot #m−1 is used for SL-I transmission to indicate corresponding SL transmission(s) in SL slot #m. The SL transmission(s) in SL slot #m may be sub-slot level SL transmission(s) (as shown in FIG. 14) or slot level SL transmission(s).

The difference between the examples illustrated in FIG. 14 and FIG. 12 only lie in that: the SL-I configuration information associated with the resources for SL-I transmission as illustrated in FIG. 14 includes a slot pattern for SL-I transmission. For example, the sub-slot pattern for SL-I transmission illustrated in FIG. 14 may be the same as slot pattern (b) in FIG. 2, but is not used for SL transmissions.

Except for the above difference, other information included in the SL-I configuration information associated with the resources for SL-I transmission as illustrated in FIG. 14 may be the same as that included in the SL-I configuration information associated with the resources for SL-I transmission as illustrated in FIG. 12. Consequently, all the definitions, principle, and methods for determining the structure of resources for SL-I transmission and the association between the resource(s) available for SL-I transmission and resource(s) for corresponding SL transmission(s) described with respect to FIG. 12 may apply for the example illustrated in FIG. 14.

Although FIGS. 8-14 take sub-slot level SL transmission as an example to illustrate the association between the resource(s) available for SL-I transmission and resource(s) for corresponding SL transmission(s), persons skilled in the art can understand all the methods described with respect to FIGS. 8-14 can also apply for the slot level SL transmission. Specifically, in the case of slot level SL transmission(s), the SL-I configuration information may include a mapping relationship between the resource set(s) and one or more slots for the corresponding SL transmission(s), where each resource set of the resource set(s) is associated with a slot of the one or more slots.

After obtaining the SL-I configuration information, the UE may perform a slot level or sub-slot level sensing procedure within a sensing window (e.g., the sensing window as shown in FIG. 5). In some embodiments of the present application, the sensing methods may include full sensing, periodic-based partial sensing (PBPS), contiguous partial sensing (CPS), and so on. The UE may use at least one of the above sensing methods to perform the sensing procedure.

Then, referring back to FIG. 7, in step 703, the UE may perform a sensing-based resource selection or sensing-based resource reselection in the RP. During the sensing-based resource selection or sensing-based resource reselection, the UE may select resources for transmitting an intended SL transmission of the UE based on the sensing results. The intended SL transmission of the UE may be a slot level SL transmission or a sub-slot level SL transmission.

Before transmitting the intended SL transmission of the UE, in step 704, the UE may perform an operation associated with SL-I according to the SL-I configuration information obtained in step 702.

According to some embodiments of the present application, step 704 may include step 705. That is, performing an operation associated with SL-I may include transmitting an SL-I. Specifically, in step 705, the UE may transmit an SL-I based on the obtained SL-I configuration information. The SL-I may indicate at least one of reserved resource(s) for the intended SL transmission of the UE or a priority of the intended SL transmission of the UE.

In some embodiments of the present application, the priority of the intended SL transmission of the UE is indicated by at least one of: a sequence type associated with the SL-I; a PRB index associated with the SL-I; a code index associated with the SL-I; or an available resource index associated with the SL-I.

Taking FIG. 3 as an example, it is assumed that: the intended SL transmission of the UE may be included in SS #0, and the priority of the intended SL transmission of the UE may be indicated by available resource index associated with the SL-I and may be priority #2. Then, the UE may transmit the SL-I in available resource index #2 in PRB set #0 in the half-symbol of SS #0 in slot #m−1 because PRB set #0 in the half-symbol in SS #0 is associated with SS #0 in slot #m, and available resource index #2 indicates priority #2.

In some embodiments of the present application, in the case that the priority threshold is indicated by the SL-I configuration information, the UE may transmit the SL-I in response to a priority of the intended SL transmission of the UE is higher than the priority threshold.

In some embodiments of the present application, in the case that the priority threshold is not indicated by the SL-I configuration information, the UE may transmit the SL-I after a resource selection or a resource reselection is triggered (e.g., after slot n in FIG. 5). Alternatively, the UE may transmit the SL-I in the case that the priority of the intended SL transmission of the UE is higher than an estimated priority of an SL transmission from another UE, wherein the SL transmission from another UE may be on resource(s) which at least partially overlap the reserved resource(s) for the intended SL transmission of the UE.

According to some embodiments of the present application, step 704 may include step 706. That is, performing an operation associated with SL-I may include checking an SL-I. Specifically, in step 706, the UE may check an SL-I based on the obtained SL-I configuration information. The SL-I may be transmitted from another UE and may indicate at least one of reserved resource(s) for an intended SL transmission of the another UE or a priority of the intended SL transmission of the another UE. The intended SL transmission of the another UE may be a slot level SL transmission or a sub-slot level SL transmission. In some embodiments of the present application, checking the SL-I may represent sensing and detection of the SL-I.

In some embodiments of the present application, the priority of the intended SL transmission of the another UE is indicated by at least one of: a sequence type associated with the SL-I; a PRB index associated with the SL-I; a code index associated with the SL-I; or an available resource index associated with the SL-I.

Taking FIG. 3 as an example, it is assumed that: the intended SL transmission of the other UE may be included in SS #0, and the priority of the intended SL transmission of the other UE may be indicated by available resource index associated with the SL-I and may be priority #2. In such embodiments, the UE may check the SL-I in available resource index #2 in set #0 in the half-symbol of SS #0 in slot #m−1. Then, after checking the SL-I, the UE may determine that there is an intended SL transmission from the other UE included in SS #0 and the priority of the intended SL transmission of the other UE is priority #2. This is because, based on the SL-I configuration information, set #0 in the half-symbol in SS #0 is associated with SS #0 in slot #m, and available resource index #2 indicates priority #2.

In some embodiments of the present application, in the case that the priority threshold is indicated by the SL-I configuration information, the UE may check the SL-I once a resource selection or a resource reselection is triggered in response to a priority of an intended SL transmission of the UE is lower than the priority threshold.

In some embodiments of the present application, in the case that the priority threshold is not indicated by the SL-I configuration information, the UE may check the SL-I once a resource selection or a resource reselection is triggered.

In some embodiments of the present application, the UE may free resources(s) originally reserved for the intended SL transmission of the UE and re-select resource(s) for the intended SL transmission of the UE once at least one of the following conditions is satisfied:
the resources(s) originally reserved for the intended SL transmission of the UE at least partially overlap the reserved resource(s) for the intended SL transmission of another UE indicated by a detected SL-I; or
the priority of the intended SL transmission of the another UE indicated by a detected SL-I is higher than the priority of the intended SL transmission of the UE.

For example, referring to FIG. 6, it is assumed that: the intended SL transmission of the UE is included in a slot #m in the time domain and four consecutive sub-channels from SCh #2 to SCh #5 in the frequency domain and has priority #1 lower than priority #2 (the priority #1 and the priority #2 used herein are only for illustrative purpose, and they are not the same as the priority values defined in 3GPP standard documents. In the 3GPP standard documents, a smaller priority value corresponds to a higher priority level); and the UE determines that an intended SL transmission from another UE is included in SS #0 in slot #m in the time domain and four consecutive sub-channels from SCh #0 to SCh #3 and has priority #2. Since resources including slot #m and SCh #2 to SCh #5 partially overlap resources including SS #0 in slot #m SCh #0 to SCh #3 and the priority of the intended SL transmission of another UE is higher than the intended SL transmission of the UE, the UE may free slot #m and re-select the resources for transmitting the intended SL transmission of the UE.

In some embodiments, the SL-I may be implemented by using a sequence (e.g., Zadoff-Chu sequence, pseudo random sequence, Gold sequence, etc.). Compared to other signaling (e.g., SCI), the above sequence carried by half-symbol or symbol can reduce the complexity as well as processing time for sensing and detection.

The benefit of the above design is allowing a UE with slot level or sub-slot level transmission to identify a resource collision with another slot level or sub-slot level transmission as early as possible, and thus the UE can perform collision avoidance in time.

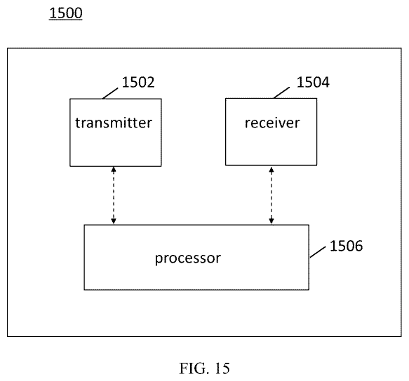

FIG. 15 illustrates a simplified block diagram of an exemplary apparatus for resource allocation according to some embodiments of the present application. In some embodiments, the apparatus 1500 may be or include at least part of a UE (e.g., UE 102a or UE 102b in FIG. 1). In some other embodiments, the apparatus 1500 may be or include at least part of a BS (e.g., BS 101 in FIG. 1).

Referring to FIG. 15, the apparatus 1500 may include at least one transmitter 1502, at least one receiver 1504, and at least one processor 1506. The at least one transmitter 1502 is coupled to the at least one processor 1506, and the at least one receiver 1504 is coupled to the at least one processor 1506.

Although in this figure, elements such as the transmitter 1502, the receiver 1504, and the processor 1506 are illustrated in the singular, the plural is contemplated unless a limitation to the singular is explicitly stated. In some embodiments of the present application, the transmitter 1502 and the receiver 1504 may be combined to one device, such as a transceiver. In some embodiments of the present application, the apparatus 1500 may further include an input device, a memory, and/or other components. The transmitter 1502, the receiver 1504, and the processor 1506 may be configured to perform any of the methods described herein (e.g., the method described with respect to any of FIGS. 7-14).

According to some embodiments of the present application, the apparatus 1500 may be a UE. In some embodiments of the present application, the processor 1506 may be configured to: obtain SL-I configuration information associated with a RP based on configuration or pre-configuration, wherein the SL-I configuration information indicates at least one of: a structure of resource(s) available for SL-I transmission; an association between the resource(s) available for SL-I transmission and resource(s) for corresponding SL transmission(s); or a priority threshold; perform a sensing-based resource selection or sensing-based resource reselection in the RP; and perform an operation associated with SL-I according to the SL-I configuration information, wherein performing the operation comprises: transmitting an SL-I indicating at least one of reserved resource(s) for an intended SL transmission of the UE or a priority of the intended SL transmission of the UE; or checking an SL-I indicating at least one of reserved resource(s) for an intended SL transmission of another UE or a priority of the intended SL transmission of the other UE.

In some embodiments of the present application, the SL-I configuration information is configured per resource pool or per zone.

In some embodiments of the present application, the processor 1506 is further configured to obtain configuration information associated with the RP, wherein the configuration information indicates at least one of: only slot level SL transmission is enabled in the RP; only sub-slot level SL transmission is enabled in the RP; or both slot level SL transmission and sub-slot level SL transmission are enabled in the RPs.

In some embodiments of the present application, the SL-I configuration information includes at least one of the following information to indicate the structure of the resource(s) available for SL-I transmission: a sub-slot pattern or a slot pattern for SL-I transmission; or half-symbol(s) or symbol(s) for SL-I transmission.

In some embodiments of the present application, the symbol(s) for SL-I transmission are included in a PSFCH.

In some embodiments of the present application, the SL-I configuration information includes at least one of the following information to indicate the structure of the resource(s) available for SL-I transmission: sub-channel(s) in each half-symbol of the half-symbol(s) or each symbol of the symbol(s) for SL-I transmission; a number of physical resource blocks (PRBs) in each sub-channel in each half-symbol of the half-symbol(s) or each symbol of the symbol(s) for SL-I transmission; a number of PRB sets in each sub-channel in each half-symbol of the half-symbol(s) or each symbol of the symbol(s) for SL-I transmission; at least one sequence type used for SL-I transmission; or at least one code used for SL-I transmission.

In some embodiments of the present application, the SL-I configuration information includes the following information to indicate the association between the resource(s) available for SL-I transmission and the resource(s) for the corresponding SL transmission(s): an association between a first group of indexes associated with the resource(s) available for SL-I transmission and a second group of indexes associated with the resource(s) for the corresponding SL transmission(s), wherein the first group of indexes includes at least one of: SL slot index(es) associated with the resource(s) available for SL-I transmission, sub-slot index(es) associated with the resource(s) available for SL-I transmission, sub-chancel index(es) associated with the resource(s) available for SL-I transmission, PRB set index(es) associated with the resource(s) available for SL-I transmission, PRB index(es) associated with the resource(s) available for SL-I transmission, code index(es) associated with the resource(s) available for SL-I transmission, or available resource index(es) associated with the resource(s) available for SL-I transmission; and wherein the second group of indexes includes at least one of: SL slot index(es) associated with the resource(s) for the corresponding SL transmission(s); sub-slot index(es) associated with the resource(s) for the corresponding SL transmission(s); or sub-chancel index(es) associated with the resource(s) for the corresponding SL transmission(s).

In some embodiments of the present application, the priority of the intended SL transmission of the UE or the priority of the intended SL transmission of the another UE is indicated by at least one of: a sequence type associated with the SL-I; a PRB index associated with the SL-I; a code index associated with the SL-I; or an available resource index associated with the SL-I.

In some embodiments of the present application, the processor 1506 is further configured to: in the case that the priority threshold is not indicated by the SL-I configuration information, check the SL-I once a resource selection or a resource reselection is triggered; or in the case that the priority threshold is indicated by the SL-I configuration information, check the SL-I once a resource selection or a resource reselection is triggered in response to a priority of an intended slot level or sub-slot level SL transmission of the UE is lower than the priority threshold.

In some embodiments of the present application, the processor 1506 is further configured to: free resources(s) originally reserved for the intended slot level or sub-slot level SL transmission of the UE and re-select resource(s) for the intended slot level or sub-slot level SL transmission of the UE once at least one of the following conditions is satisfied: the resources(s) originally reserved for the intended slot level or sub-slot level SL transmission of the UE at least partially overlap the reserved resource(s) for the intended SL transmission of the other UE indicated by a detected SL-I; or the priority of the intended SL transmission of the other UE indicated by a detected SL-I is higher than the priority of the intended slot level or sub-slot level SL transmission of the UE.

In some embodiments of the present application, the processor 1506 is further configured to: in the case that the priority threshold is indicated by the SL-I configuration information, transmit the SL-I in response to a priority of the intended SL transmission of the UE is higher than the priority threshold; or in the case that the priority threshold is not indicated by the SL-I configuration information: transmit the SL-I after a resource selection or a resource reselection is triggered; or transmit the SL-I in the case that the priority of the intended SL transmission of the UE is higher than an estimated priority of an SL transmission from another UE on resource(s) which at least partially overlap the reserved resource(s) for the intended SL transmission of the UE.

According to some other embodiments of the present application, the apparatus 1500 may be a BS. In some embodiments of the present application, the transmitter 1502 is configured to transmit at least one of the following information: SL-I configuration information associated with a RP, wherein the SL-I configuration information indicates at least one of: a structure of resource(s) available for SL-I transmission; an association between the resource(s) available for SL-I transmission and resource(s) for corresponding SL transmission(s); or a priority threshold; or configuration information associated with the RP, wherein the configuration information indicates at least one of: only slot level SL transmission is enabled in the RP; only sub-slot level SL transmission is enabled in the RP; or both slot level SL transmission and sub-slot level SL transmission are enabled in the RP.

In some embodiments of the present application, the apparatus 1500 may further include at least one non-transitory computer-readable medium. In some embodiments of the present application, the non-transitory computer-readable medium may have stored thereon computer-executable instructions to cause the processor 1506 to implement any of the methods as described above. For example, the computer-executable instructions, when executed, may cause the processor 1506 to interact with the transmitter 1502 and/or the receiver 1504, so as to perform operations of the methods, e.g., as described with respect to FIGS. 7-14.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus of resource allocation for SL communication, including a processor and a memory. Computer programmable instructions for implementing a method of resource allocation for SL communication are stored in the memory, and the processor is configured to perform the computer programmable instructions to implement the method of resource allocation for SL communication. The method of resource allocation for SL communication may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method of resource allocation for SL communication according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE) for wireless communication, the UE comprising:
a memory; and
a processor coupled to the memory and configured to cause the UE to:
obtain sidelink (SL) indicator (SL-I) configuration information associated with a resource pool (RP) based on configuration or pre-configuration, wherein the SL-I configuration information indicates at least one of:
a structure of resource(s) available for SL-I transmission;
an association between the resource(s) available for SL-I transmission and resource(s) for corresponding SL transmission(s); or
a priority threshold;
perform a sensing-based resource selection or sensing-based resource reselection in the RP; and
perform an operation associated with SL-I according to the SL-I configuration information, wherein performing the operation comprises:
transmitting an SL-I indicating at least one of reserved resource(s) for an intended SL transmission of the UE or a priority of the intended SL transmission of the UE; or
checking an SL-I indicating at least one of reserved resource(s) for an intended SL transmission of another UE or a priority of the intended SL transmission of the another UE.

2. The UE of claim 1, wherein the SL-I configuration information is configured per resource pool or per zone.

3. The UE of claim 1, wherein the processor is further configured to obtain configuration information associated with the RP, wherein the configuration information indicates at least one of:
only slot level SL transmission is enabled in the RP;
only sub-slot level SL transmission is enabled in the RP; or
both slot level SL transmission and sub-slot level SL transmission are enabled in the RP.

4. The UE of claim 1, wherein the SL-I configuration information includes at least one of the following information to indicate the structure of the resource(s) available for SL-I transmission:
a sub-slot pattern or a slot pattern for SL-I transmission; or
half-symbol(s) or symbol(s) for SL-I transmission.

5. The UE of claim 4, wherein the symbol(s) for SL-I transmission are included in a physical sidelink feedback channel (PSFCH).

6. The UE of claim 4, wherein the SL-I configuration information includes at least one of the following information to indicate the structure of the resource(s) available for SL-I transmission:
sub-channel(s) in each half-symbol of the half-symbol(s) or each symbol of the symbol(s) for SL-I transmission;
a number of physical resource blocks (PRBs) in each sub-channel in each half-symbol of the half-symbol(s) or each symbol of the symbol(s) for SL-I transmission;
a number of PRB sets in each sub-channel in each half-symbol of the half-symbol(s) or each symbol of the symbol(s) for SL-I transmission;
at least one sequence type used for SL-I transmission; or
at least one code used for SL-I transmission.

7. The UE of claim 1, wherein the SL-I configuration information comprises the following information to indicate the association between the resource(s) available for SL-I transmission and the resource(s) for the corresponding SL transmission(s):
an association between a first group of indexes associated with the resource(s) available for SL-I transmission and a second group of indexes associated with the resource(s) for the corresponding SL transmission(s),
wherein the first group of indexes includes at least one of:
SL slot index(es) associated with the resource(s) available for SL-I transmission,
sub-slot index(es) associated with the resource(s) available for SL-I transmission,
sub-chancel index(es) associated with the resource(s) available for SL-I transmission,
PRB set index(es) associated with the resource(s) available for SL-I transmission,
PRB index(es) associated with the resource(s) available for SL-I transmission,
code index(es) associated with the resource(s) available for SL-I transmission, or
available resource index(es) associated with the resource(s) available for SL-I transmission; and
wherein the second group of indexes includes at least one of:
SL slot index(es) associated with the resource(s) for the corresponding SL transmission(s);
sub-slot index(es) associated with the resource(s) for the corresponding SL transmission(s); or
sub-chancel index(es) associated with the resource(s) for the corresponding SL transmission(s).

8. The UE of claim 1, wherein the priority of the intended SL transmission of the UE or the priority of the intended SL transmission of the other UE is indicated by at least one of:
a sequence type associated with the SL-I;
a PRB index associated with the SL-I;
a code index associated with the SL-I; or
an available resource index associated with the SL-I.

9. The UE of claim 1, wherein the processor is configured to cause the UE to perform one of:
in the case that the priority threshold is not indicated by the SL-I configuration information, check the SL-I once a resource selection or a resource reselection is triggered; or
in the case that the priority threshold is indicated by the SL-I configuration information, check the SL-I once a resource selection or a resource reselection is triggered in response to a priority of an intended slot level or sub-slot level SL transmission of the UE being lower than the priority threshold.

10. The UE of claim 9, wherein the processor is further configured to:
free resources(s) originally reserved for the intended slot level or sub-slot level SL transmission of the UE and re-select resource(s) for the intended slot level or sub-slot level SL transmission of the UE once at least one of the following conditions is satisfied:
the resources(s) originally reserved for the intended slot level or sub-slot level SL transmission of the UE at least partially overlap the reserved resource(s) for the intended SL transmission of the other UE indicated by a detected SL-I; or
the priority of the intended SL transmission of the other UE indicated by a detected SL-I is higher than the priority of the intended slot level or sub-slot level SL transmission of the UE.

11. The UE of claim 1, wherein the processor is further configured to:
in the case that the priority threshold is indicated by the SL-I configuration information, transmit the SL-I in response to a priority of the intended SL transmission of the UE being higher than the priority threshold; or
in the case that the priority threshold is not indicated by the SL-I configuration information:
transmit the SL-I after a resource selection or a resource reselection is triggered; or
transmit the SL-I in the case that the priority of the intended SL transmission of the UE is higher than an estimated priority of an SL transmission from another UE on resource(s) which at least partially overlap the reserved resource(s) for the intended SL transmission of the UE.

12. (canceled)

13. A method performed by a user equipment (UE), the method comprising:
obtaining sidelink (SL) indicator (SL-I) configuration information associated with a resource pool (RP) based on configuration or pre-configuration, wherein the SL-I configuration information indicates at least one of:
a structure of resource(s) available for SL-I transmission;
an association between the resource(s) available for SL-I transmission and resource(s) for corresponding SL transmission(s); or
a priority threshold;
performing a sensing-based resource selection or a sensing-based resource reselection in the RP; and
performing an operation associated with SL-I according to the SL-I configuration information, wherein performing the operation comprises:
transmitting an SL-I indicating at least one of reserved resource(s) for an intended SL transmission of the UE or a priority of the intended SL transmission of the UE; or
checking an SL-I indicating at least one of reserved resource(s) for an intended SL transmission of another UE or a priority of the intended SL transmission of the other UE.

14. (canceled)

15. The method of claim 13, further comprising:
obtaining configuration information associated with the RP, wherein the configuration information indicates at least one of:
only slot level SL transmission is enabled in the RP;
only sub-slot level SL transmission is enabled in the RP; or
both slot level SL transmission and sub-slot level SL transmission are enabled in the RP.

16. A base station (BS) for wireless communication, the base station comprising:
a memory;
a transmitter; and
a processor coupled to the memory and the transmitter and configured to cause the base station to transmit, via the transmitter, at least one of the following information:
sidelink (SL) indicator (SL-I) configuration information associated with a resource pool (RP), wherein the SL-I configuration information indicates at least one of:
a structure of resource(s) available for SL-I transmission;
an association between the resource(s) available for SL-I transmission and resource(s) for corresponding SL transmission(s); or
a priority threshold; or
configuration information associated with the RP, wherein the configuration information indicates at least one of:
only slot level SL transmission is enabled in the RP;
only sub-slot level SL transmission is enabled in the RP; or
both slot level SL transmission and sub-slot level SL transmission are enabled in the RP.

17. The base station of claim 16, wherein the processor is further configured to cause the base station to transmit configuration information associated with the RP, wherein the configuration information indicates at least one of:
only slot level SL transmission is enabled in the RP;
only sub-slot level SL transmission is enabled in the RP; or
both slot level SL transmission and sub-slot level SL transmission are enabled in the RP.

18. The base station of claim 16, wherein the SL-I configuration information is configured per resource pool or per zone.

19. The base station of claim 16, wherein the SL-I configuration information includes at least one of the following information to indicate the structure of the resource(s) available for SL-I transmission:
a sub-slot pattern or a slot pattern for SL-I transmission; or
half-symbol(s) or symbol(s) for SL-I transmission.

20. The base station of claim 19, wherein the symbol(s) for SL-I transmission are included in a physical sidelink feedback channel (PSFCH).

21. The UE of claim 19, wherein the SL-I configuration information includes at least one of the following information to indicate the structure of the resource(s) available for SL-I transmission:
sub-channel(s) in each half-symbol of the half-symbol(s) or each symbol of the symbol(s) for SL-I transmission;
a number of physical resource blocks (PRBs) in each sub-channel in each half-symbol of the half-symbol(s) or each symbol of the symbol(s) for SL-I transmission;
a number of PRB sets in each sub-channel in each half-symbol of the half-symbol(s) or each symbol of the symbol(s) for SL-I transmission;
at least one sequence type used for SL-I transmission; or
at least one code used for SL-I transmission.

22. The base station of claim 16, wherein the SL-I configuration information comprises the following information to indicate the association between the resource(s) available for SL-I transmission and the resource(s) for the corresponding SL transmission(s):
an association between a first group of indexes associated with the resource(s) available for SL-I transmission and a second group of indexes associated with the resource(s) for the corresponding SL transmission(s),
wherein the first group of indexes includes at least one of:
SL slot index(es) associated with the resource(s) available for SL-I transmission,
sub-slot index(es) associated with the resource(s) available for SL-I transmission,
sub-chancel index(es) associated with the resource(s) available for SL-I transmission,
PRB set index(es) associated with the resource(s) available for SL-I transmission,
PRB index(es) associated with the resource(s) available for SL-I transmission,
code index(es) associated with the resource(s) available for SL-I transmission, or
available resource index(es) associated with the resource(s) available for SL-I transmission; and
wherein the second group of indexes includes at least one of:
SL slot index(es) associated with the resource(s) for the corresponding SL transmission(s);
sub-slot index(es) associated with the resource(s) for the corresponding SL transmission(s); or
sub-chancel index(es) associated with the resource(s) for the corresponding SL transmission(s).
